(19) United States
(12) Patent Application Publication
(10) Pub. No.: US 2025/0380169 A1
(43) Pub. Date: Dec. 11, 2025

(54) SYSTEMS, METHODS, AND DEVICES FOR MAC HANDLING OF mTRPs FOR INTER-DU, INTRA-CU MOBILITY OF UE

(71) Applicant: Apple Inc., Cupertino, CA (US)

(72) Inventors: Fangli Xu, Beijing (CN); Naveen Kumar R Palle Venkata, San Diego, CA (US); Haijing Hu, Los Gatos, CA (US); Birgit Breining, Muenchen (DE); Yuqin Chen, Beijing (CN); Srirang A Lovlekar, Fremont, CA (US); Ralf Rossbach, Munich (DE); Alexander Sirotkin, Hod Hasharon (IL); Zhibin Wu, Los Altos, CA (US); Pavan Nuggehalli, San Carlos, CA (US); Sethuraman Gurumoorthy, San Ramon, CA (US)

(21) Appl. No.: 18/877,087

(22) PCT Filed: Jun. 28, 2022
(86) PCT No.: PCT/CN2022/101969

§ 371 Date: Dec. 19, 2024

(51) Int. Cl. H04W 24/10; H04L 1/1812; H04W 76/20; H04W 80/02

(52) U.S. Cl. CPC H04W 24/10; H04L 1/1812; H04W 76/20; H04W 80/02

(57) ABSTRACT

Techniques, described herein, include solutions for handling multiple transmission and reception points (mTRPs) for inter-distributed unit (DU), intra-centralized unit (CU) mobility of user equipment (UE). DUs may each implement a media access control (MAC) layer, and a CU may add a new DU by configuring the DU to implement an instance of a hybrid automatic repeat request (HARQ) entity operating on an existing DU. HARQ processes associated with each DU may be the same or different and the UE may be configured accordingly. The UE may use the same MAC entity to communicate with each DU. In some implementations, HARQ entities of DUs may be associated with mTRP IDs. Alternatively, a new MAC and/or RLC layer may be implemented in the new DU and the UE may be configured accordingly. RLC layers may be radio bearer (RB) or logical channel specific.

### FIELD

This disclosure relates to wireless communication networks including techniques for conserving power within wireless communication networks.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes device mobility, which may include processes and procedures for enabling a mobile device to move about a network from one wireless network node to another.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview of media access control (MAC) handling of multiple transmission reception points (mTRPs) for inter-distributed unit (DU), intra-centralized unit (CU) mobility according to one or more implementations described herein.

FIG. 2 is a diagram of an example network according to one or more implementations described herein.

FIG. 3 is a diagram of an example of a process for inter-distributed unit (DU), intra-centralized unit (CU) mobility based on hybrid automatic repeat request (HARQ) processes according to one or more implementations described herein.

FIGS. 4-5 are diagrams of examples of enhanced radio resource control (RRC) information elements (IEs) for inter-DU, intra-CU mobility based on HARQ processes according to one or more implementations described herein.

FIG. 6 is a diagram of an example of a process for inter-DU, intra-CU mobility based on HARQ processes according to one or more implementations described herein.

FIGS. 7-8 are diagrams of examples of enhanced RRC IEs for inter-DU, intra-CU mobility based on HARQ processes according to one or more implementations described herein.

FIG. 9 is a diagram of an example of a process for inter-DU, intra-CU mobility based on mTRP ID according to one or more implementations described herein.

FIG. 10 is a diagram of an example of enhanced RRC IE for inter-DU, intra-CU mobility based on TRP ID according to one or more implementations described herein.

FIG. 11 is a diagram of an example of a process for inter-DU, intra-CU mobility based on a dual MAC architecture according to one or more implementations described herein.

FIG. 12 is a diagram of an example of enhanced RRC IE for inter-DU, intra-CU mobility based on a dual MAC architecture according to one or more implementations described herein.

FIG. 13 is a diagram of an example of a process for inter-DU, intra-CU mobility based on a dual MAC and radio link control (RLC) architecture according to one or more implementations described herein.

FIG. 14 is a diagram of an example of enhanced RRC IE for inter-DU, intra-CU mobility based on a dual MAC and RLC architecture according to one or more implementations described herein.

FIG. 15 is a diagram of an example of a process for inter-DU, intra-CU mobility based on a dual MAC and RLC architecture according to one or more implementations described herein.

FIG. 16 is a diagram of an example of enhanced RRC IE for inter-DU, intra-CU mobility based on a dual MAC and RLC architecture according to one or more implementations described herein.

FIG. 17 is a diagram of an example of components of a device according to one or more implementations described herein.

FIG. 18 is a diagram of example interfaces of baseband circuitry according to one or more implementations described herein.

FIG. 19 is a block diagram of an example control plane protocol stack according to one or more implementations described herein.

FIG. 20 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity. Examples of such techniques may include multiple input multiple output (MIMO), enhanced MIMO (eMIMO), further enhanced MIMO (FeMIMO), carrier aggregation (CA), and dual connectivity (DC).

In networks implementing 5th generation (5G) or new radio (NR) communication standards of the 3rd generation partnership project (3GPP), a base station may be implemented using different types of architectures. For example, a base station may be a standalone base station, a non-standalone base station, or a so-called centralized unit (CU) and distributed unit (DU) split base station (also referred to as a CU-DU split base station).

A CU may comprise a control plane (CP) portion (CU-CP) and a user plane (UP) portion (CU-UP). The CU-CP may support higher layers of the protocol stack, such as support service data adaptation protocol (SDAP), radio resource control (RRC), and packet data convergence protocol (PDCP). A CU may communicate with multiple DUs via an F1 interface (e.g., an F1-C interface for control plane communications and an F1-U for user plane communications (which may include general packet radio service (GPRS) tunneling protocol (GTP) user data tunnels (GTP-U tunnels)).

A DU may support lower layers of the protocol stack, such as radio link control (RLC), media access control (MAC), and physical layer (PHY). A DU may also include both baseband processing and RF functions and may operate as one or more transmission and reception points (TRPs or multiple TRPs (mTRPs). A DU may also support one or more cells that may have different physical cell IDs (PCIs) and support multiple beams, and may support one or more mobility scenarios, including intra-TRP mobility, intra-cell mobility, and intra-DU mobility.

While currently available technologies enable some types of mobility, currently available technologies fail to adequately enable other types of UE mobility, such as inter-DU, intra-CU mobility—that is, the ability of a UE to move between DUs, of the same CU, but using different frequencies, in different cells, and with different timing advances (TAs). These and other limitations relate to inadequately integrating the MAC layer with the functions and operations of DUs. For example, depending on the network configuration, a UE might be limited to applying MIMO based on a single hybrid automatic repeat request (HARQ) entity for co-located DUs with a single MAC layer, or be limited to applying MIMO based on multiple HARQ entities for non-co-located DUs with different MAC layers.

Techniques, described herein, provide solutions for MAC handling of mTRPs for inter-DU, intra-CU mobility of UEs. In some implementations, DUs may each implement a MAC layer, and a CU may add a new DU by configuring the DU to implement an instance of a HARQ entity operating on an existing DU (e.g., so that both DUs implement a HARQ entity with the same HARQ ID). The CU may also assign HARQ process IDs to the new DU that are different from the HARQ process IDs used by the existing DU. The CU may then configure the UE to associate each DU with a corresponding set of HARQ processes. In some implementations, the new DU may decide which HARQ processes to add. Additionally, or alternatively, the CU may configure the UE to associate HARQ processes to the new DU based on a TRP ID of the DU. In some implementations, a new MAC and/or RLC layer may be implemented in the new DU and the UE may be configured accordingly. As such, the techniques, described herein, may enable DUs to operate as individual cells/base stations and therefore enable inter-DU, intra-CU mobility of UEs.

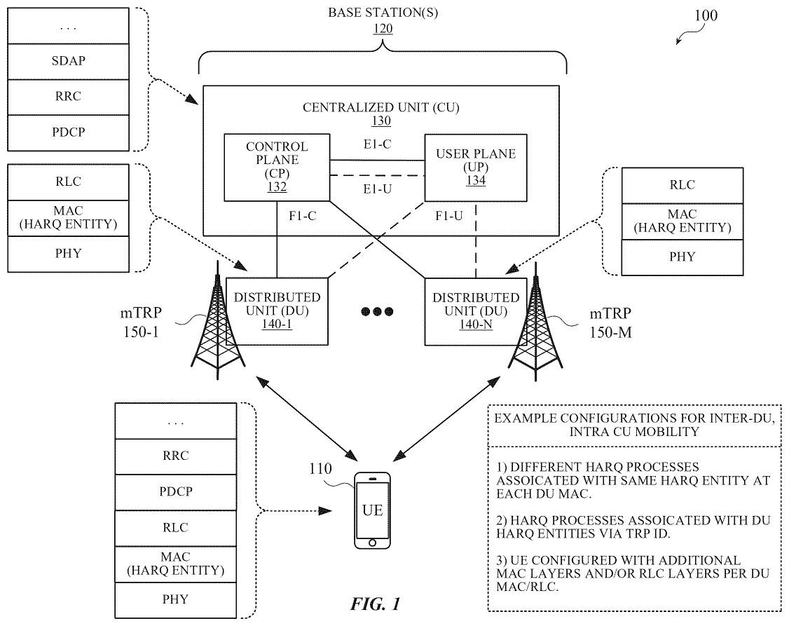

FIG. 1 is a diagram of an example overview 100 of MAC handling of mTRPs for inter-DU, intra-CU mobility according to one or more implementations described herein. As shown, overview 100 may include UE 110 and base station 120. Base station 120 may include a CU 130, DU 140-1 through DU 140-N (where N is greater than 1, and collectively referred to as “DUs 140”), and mTRP 150-1 through mTRP 150-M (where M is greater than 1 and collectively referred to “mTRPs 150”). Each DU 140 of FIG. 1 is depicted as corresponding to one mTRP 150; however, the techniques describe herein include implementations where one DU 140 may correspond to multiple mTRPs 150.

CU 130 may include a control plane (CP) 132 and a user plane (UP) 134 that communicate with each other via an E1-C interface for control information and an E1-U interface for user data. CP 132 and UP 134 may communicate with DUs 140 using an F1-C interface for control information and an F1-U interface for user data. CU 130 may support higher layer protocols, such as SDAP, RRC, and PDCP. DUs 140 may support lower layer protocols, such as RLC, MAC, and PHY. DUs 140 may also include baseband processing and RF functions and may operate one or more mTRPs 150. mTPRs 150 may be part of different cells, have different PCIs, be non-co-located with respect to one another (e.g., be located at a distance from one another, use different frequency bands, broadcast different have different system synchronization blocks (SSBs), have different TAs, etc.).

Inter-DU, intra-CU mobility may be enabled by CU 130 causing DUs 140, with mTRPs 150 having different PCIs, to implement MAC layers with the same HARQ entity (e.g., HARQ entities using the same HARQ ID). CU 130 may allocate different HARQ processes of the HARQ entity to each DU 140 and use RRC messaging to configure UE 110 to communicate with DUs 140 using the assigned HARQ processes. Downlink control information (DCI) from DUs 140 may be used to provide UE 110 with the HARQ ID. DUs 140 using different MAC layers, and having different mTRPs 150 with different PCIs, may enable DUs 140 to be unsynchronized (e.g., be located at a distance from one another, use different frequency bands, broadcast different have different SSBs, have different TAs, etc.). In other words, DUs 140 and mTRPs 150 may operate as individual cells/base stations and therefore enable inter-DU mobility for UE 110. In the absence of one or more of the configurations described above, UE 110 may be configured to assume that HARQ processes correspond to the same HARQ entity (e.g., HARQ ID) and are shared across all DUs 140.

In some implementations, the new DU 140 (instead of CU 130) may decide which HARQ processes to support, and CU 130 may configure UE 110 to associate those HARQ processes to the new DU 140. In some implementations, each DU 140 may implement the same HARQ entity (e.g., with the same HARQ ID) and each DU 140 may use HARQ processes with the same HARQ process IDs. In such implementations, CU 130 may configure UE 110 to differentiate between DUs 140 based on mTRPs 150 (e.g., PCIs of the mTRPs 150). In some implementations, CU 130 may implement a dual-MAC architecture where UE 110 may implement a new instance of the MAC layer that corresponds to the MAC layer of a new DU 140 and is released when the new DU 140 (and/or mTRP 150) is released. In some implementations, CU 130 may implement a dual-RLC architecture where UE 110 may implement a new instance of the MAC and RLC layers, which correspond to the MAC and RLC layers of a new DU 140. The new instance of the MAC and RLC layers may be released when the new DU 140 (and/or mTRP 150) is released.

Generally, one MAC entity may include one HARQ entity, and each HARQ entity may handle many HARQ processes. Traffic may be distributed among the processes of the HARQ entity. Each process may handle one transport (TB) at a time, but if DL spatial multiplexing is configured, for example, two TBs may be used. In DL, HARQ processes may also be used for slot aggregation, also called transmission time interval (TTI) bundling. In such a scenario, a TB may be retransmitted without waiting for an acknowledgement (ACK). At the MAC layer, a new data indicator (NDI) may be used to determine if a received TB is a new transmission or a retransmission. When the NDI is toggled in DCI, it may imply new DL data. Toggling NDI in a UL grant may inform the UE to send new data. When a retransmitted TB is received, the MAC layer may inform the PHY layer to combine current and previous transmissions of the TB. Thus, the PHY layer may be responsible for soft combining and decoding.

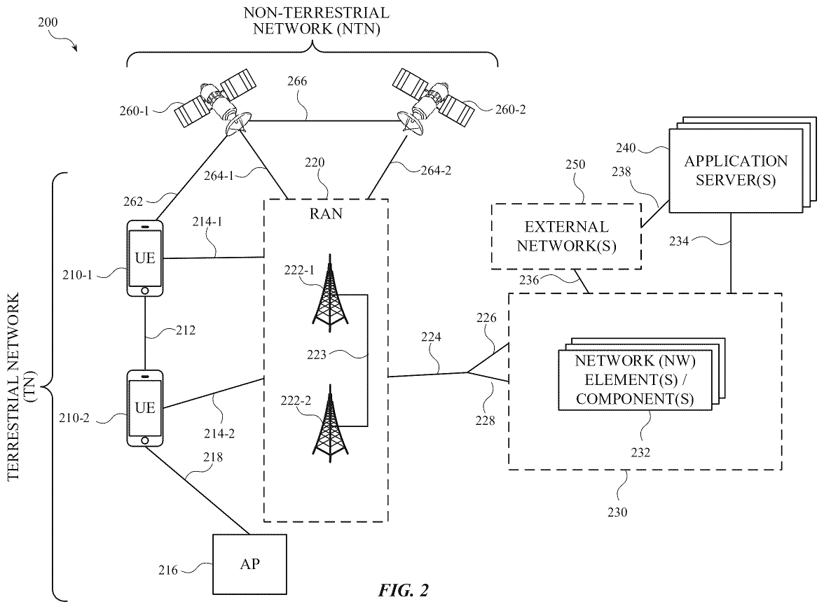

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 may include a non-terrestrial network (NTN) comprising one or more satellites 260 (e.g., of a global navigation satellite system (GNSS)) in communication with UEs 210 and RAN 220.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, etc. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 201, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network nod 222.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and also to implementation where the base station, RAN node 222, etc., is a non-terrestrial network node (e.g., satellite 260).

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 210 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 210 and the RAN nodes 222 may also operate using stand-alone unlicensed operation where the UE may be configured with a PCell, in addition to any SCells, in unlicensed spectrum.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

As shown, example network 200 may include an NTN that may comprise one or more satellites 260-1 and 260-2 (collectively, “satellites 260”). Satellites 260 may be in communication with UEs 210 via service link or wireless interface 262 and/or RAN 220 via feeder links or wireless interfaces 264 (depicted individually as 264-1 and 264). In some implementations, satellite 260 may operate as a passive or transparent network relay node regarding communications between UE 210 and the terrestrial network (e.g., RAN 220). In some implementations, satellite 260 may operate as an active or regenerative network node such that satellite 260 may operate as a base station to UEs 210 (e.g., as a gNB of RAN 220) regarding communications between UE 210 and RAN 220. In some implementations, satellites 260 may communicate with one another via a direct wireless interface (e.g., 266) or an indirect wireless interface (e.g., via RAN 220 using interfaces 264-1 and 264-2).

Additionally, or alternatively, satellite 260 may include a GEO satellite, LEO satellite, or another type of satellite. Satellite 260 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and implementation, where the base station, RAN node 222, etc., is a non-terrestrial network node (e.g., satellite 260). As described herein, UE 210 and base station 222 may communicate with one another, via interface 214, to enable enhanced power saving techniques.

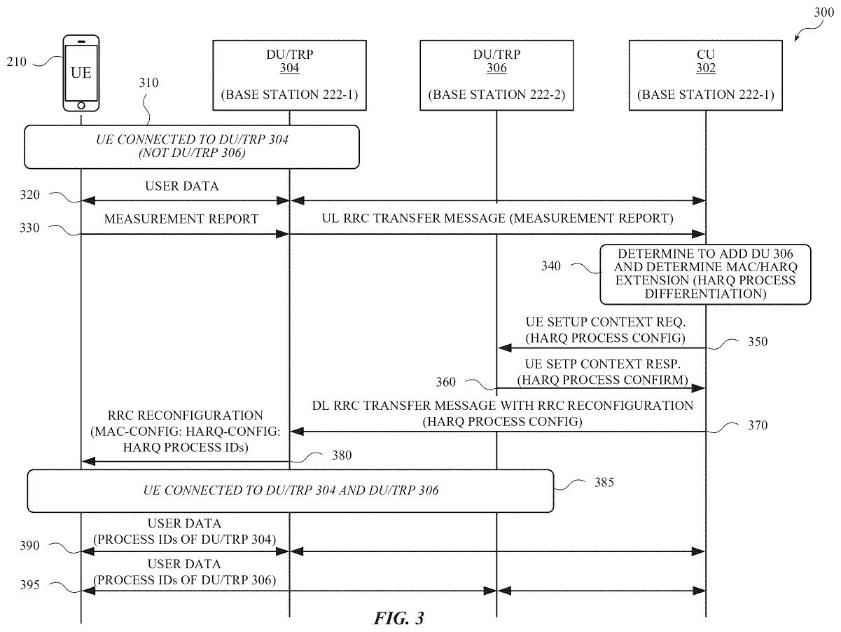

FIG. 3 is a diagram of an example of a process 300 for inter-DU, intra-CU mobility based on HARQ processes according to one or more implementations described herein. As shown, process 300 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 300 may be performed by one or more other systems or devices, including one or more of the devices of FIG. 1 or 2. Additionally, process 300 may include one or more fewer, additional, differently ordered and/or arranged operations than those shown in FIG. 3. In some implementations, one or more of the operations of process 300 may be performed independently, successively, simultaneously, etc., of one or more of the other operations of process 300. As such, the techniques described herein are not limited to the number, sequence, arrangement, timing, etc., of the operations or process depicted in FIG. 3. Additionally, an implementation involving one or more of the operations of process 300 may include one or more operations or functions of another example described herein.

As shown, process 300 may include UE 210 being connected to DU 304 of base station 222-1 (at 310). By extension, though not shown, UE 210 may also be connected to CU 302 of base station 222-1. As such, UE 210 may transmit and receive user data from base station 222-1 via DU 304 and CU 306 (at 320). UE 210 may not be connected to DU 306 of base station 222-2.

UE 210 may periodically detect and measure signals broadcasted by base stations 222 in the area. UE 210 may send a measurement report, describing the signals detected and corresponding base stations 222 and signal strengths, to DU 304, and DU 304 may send the measurement report to CU 302 (at 330). The measurement report may be sent via a UL RRC transfer message. CU 302 may receive the measurement report and determine to enable a connection between UE 210 and DU 306 and may also determine an appropriate MAC/HARQ extension (at 340) for doing so. The MAC/HARQ extension may include a HARQ process differentiation technique where DU 304 and DU 306 each have a MAC layer that implements a HARQ entity with the same HARQ ID; however, some of the HARQ processes (e.g., HARQ process IDs, HARQ process numbers, etc.) associated with the HARQ entity (e.g., HARQ ID) may be assigned or associated to DU 304 while other HARQ processes associated with the HARQ entity may be assigned or associated to DU 306. Consequently, UE 210 may use a single MAC layer and HARQ entity to communicate with DU 304 and DU 306. While not shown, DU 306 may release or terminate the MAC/HARQ configuration in response to UE 210 moving out of a coverage area of the DU 306, in response to an explicit release message from UE 210, CU 203, or another device or entity, or in response to another release trigger. As such, inter-DU, intra CU mobility of UE 210 may be enabled by configuring the MAC layers of DUs with the HARQ entity and corresponding HARQ processes.

As shown, process 300 may include CU 302 sending HARQ process configuration information to DU 306 (at 350). The HARQ process configuration information may be sent via a UE setup context request message or another type of message. The HARQ process configuration information may cause DU 306 to create HARQ entity at the MAC layer of DU 306 using the same HARQ ID as the HARQ entity used by DU 304 for UE 210. The HARQ process configuration information may also indicate which HARQ processes (e.g., which HARQ process IDs or HARQ process numbers) correspond to DU 306 and/or DU 304. For example, HARQ processes 1-8 of HARQ ID X may correspond to DU 304, and HARQ processes 9-16 of HARQ ID X may correspond to DU 306. DU 306 may respond by sending HARQ process confirmation information to CU 302 (at 360). The HARQ process confirmation information may be sent via a UE setup context response message or another type of message. The HARQ process confirmation information may indicate to CU 302 that DU 306 is configured according to the HARQ process configuration information received previously.

CU 302 may send HARQ process configuration information to DU 304 (at 370). The HARQ process configuration information may be sent via a DL RRC transfer message or another type of message. The DL RRC transfer message may include an RRC reconfiguration message (e.g., an RRCReconfiguration message). The HARQ process configuration information may indicate the MAC/HARQ configuration of DU 304 and DU 306. For example, the HARQ process configuration information may indicate a HARQ entity (e.g., HARQ ID) for communicating with DU 304 and DU 306. Additionally, or alternatively, the HARQ process configuration information may indicate which HARQ processes, of the HARQ entity, correspond to DU 304 and which correspond to DU 306. In some implementations, in the event that UE 210 is to release another DU (not shown), the HARQ process configuration information may also indicate the DU and HARQ processes that should be released for that DU. In such implementations, one or more of the released HARQ processes may be reused by UE 210 to communicate with DU 304 or DU 306.

DU 304 may send an RRC reconfiguration message to UE 210 (at 380). In some implementations, one or more other types of messages may be used. The RRC reconfiguration message may include information and instructions for UE 210 to establish a connection with DU 306. In some implementations, the RRC reconfiguration message may also include information and instructions for UE 210 to reestablish or reconfigure an existing connection with DU 304. UE 210 may respond to the RRC reconfiguration message by configuring a MAC layer of UE 210 according to the HARQ entity (e.g., HARQ ID) and corresponding HARQ processes (e.g., HARQ process IDs) of DU 304 and DU 306. In such implementations, DCI from DU 304 and/or DU 306 may indicate the HARQ ID of the HARQ entity supported by DU 304 and/or DU 306. If/when there is a new ID, then bits of the DCI may reflect the new ID.

UE 210 may use the information in the RRC reconfiguration message to establish a connection with the TRPs of DU 304 and/or DU 306 (at 385). In some implementations, UE 210 may maintain the connection previously established with DU 304 (e.g., at 310) and establish an additional connection with DU 306. In some implementations, UE 210 may adjust, based on the RRC reconfiguration message, the connection previously established with DU 304 (e.g., at 310) and establish an additional connection with DU 306. In some implementations, UE 210 may establish, based on the RRC reconfiguration message, new connections with each of DU 304 and 306. UE 210 may use the connections to communicate user data (e.g., user plane information) to the network. UE 210 may communicate with DU 304 and CU 302 based on the HARQ processes associated with DU 304 (at 390). UE may communicate with DU 306 and CU 302 based on the HARQ processes associated with DU 306 (at 395). UE 210 may continue to periodically measure radio signals from base stations in the area, send measurement reports to CU 302, etc., to enable inter-DU, intra-CU mobility for UE 210 by repeating one or more of the operations of process 300.

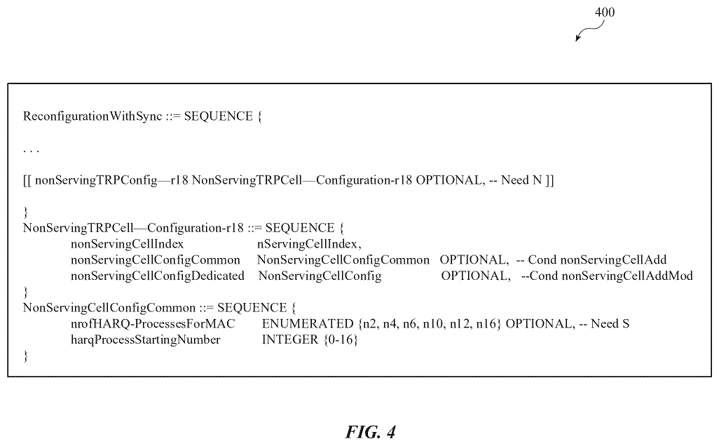

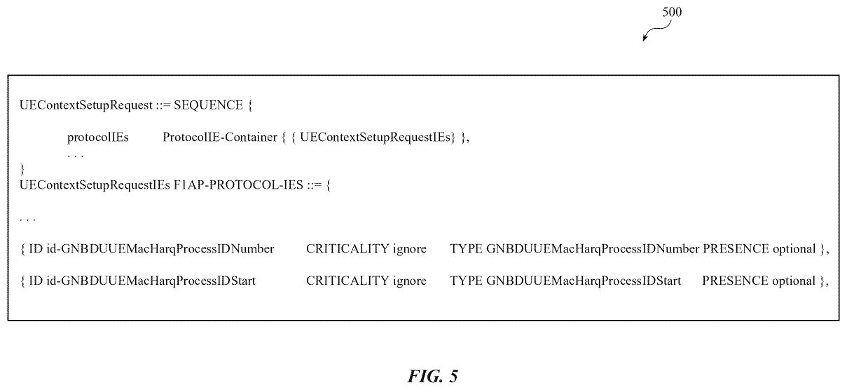

FIGS. 4-5 are diagrams of examples 400 and 500 of enhanced RRC messages and/or information elements (IEs) for inter-DU, intra-CU mobility based on HARQ processes according to one or more implementations described herein. In some implementations, examples 400 and 500 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use one or more of the example 400 and 500 to implement one or more of the techniques described herein. In other implementations, CU 302, DU 304, DU 306, and/or UE 210 may use one or more additional, alternative, or differently arranged messages and/or IEs. As such, FIGS. 4-5 are provided as non-limiting examples.

Example 400 may include information and instructions that CU 302 may use to configure/reconfigure UE 210 in accordance with FIG. 3. Example 400 may be part of an RRC reconfiguration message sent from CU 302 to UE 210 (relayed by DU 304) so that UE 210 may establish a connection with DU 306. As shown, example 400 may include information and instructions for adding or modifying a non-serving TRP (see, e.g., NonServingTRPCell-Configuration, nonServingCellIndex and nonServingCellConfigCommon). Example 400 may include information and instructions for indicating a number of HARQ processes for the TRP and starting number for the HARQ processes (see, e.g., nrofHARQ-ProcessesForMAC and harqProcessStartingNumber).

Example 500 may include information and instructions that CU 302 may use to configure/reconfigure DU 306 with an appropriate MAC/HARQ entity. Example 500 may correspond to a UE context setup request message or another type of message sent from CU 302 to DU 306 via the F1 inter-node interface (see, e.g., UEContextSetupRequest, UEContextSetupRequestIEs, and F1AP-PROTOCOL-IES). Example 500 may also include information indicating MAC HARQ process ID numbers for UE 210 DU 306 communications and corresponding starting positions (see, e.g., id-GNBDUUEMacHarqProcessIDNumber and id-GNBDUUEMacHarqProcessIDStart).

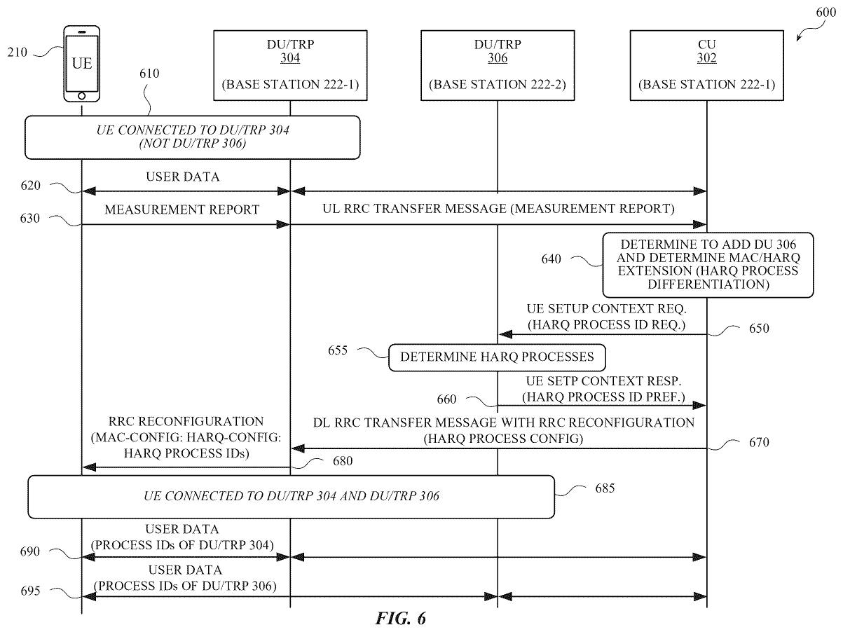

FIG. 6 is a diagram of an example of a process 600 for inter-DU, intra-CU mobility based on HARQ processes according to one or more implementations described herein. As shown, process 600 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 600 may be performed by one or more other systems or devices, including one or more of the devices of FIG. 1 or 2. Additionally, process 600 may include one or more fewer, additional, differently ordered and/or arranged operations than those shown in FIG. 6. In some implementations, one or more of the operations of process 600 may be performed independently, successively, simultaneously, etc., of one or more of the other operations of process 600. As such, the techniques described herein are not limited to the number, sequence, arrangement, timing, etc., of the operations or process depicted in FIG. 6. Additionally, an implementation involving one or more of the operations of process 600 may include one or more operations or functions of another example described herein.

As shown, process 600 may include UE 210 being connected to DU 304 of base station 222-1 (at 610). By extension, though not shown, UE 210 may also be connected to CU 302 of base station 222-1. As such, UE 210 may transmit and receive user data from base station 222-1 via DU 304 and CU 306 (at 620). UE 210 may not be connected to DU 306 of base station 222-2.

UE 210 may periodically detect and measure signals broadcasted by base stations 222 in the area. UE 210 may send a measurement report, describing the signals detected and corresponding base stations 222 and signal strengths, to DU 304, and DU 304 may send the measurement report to CU 302 (at 630). The measurement report may be sent via a UL RRC transfer message. CU 302 may receive the measurement report and determine to enable a connection between UE 210 and DU 306 and may also determine an appropriate MAC/HARQ extension (at 640) for doing so. The MAC/HARQ extension may include a HARQ process differentiation technique where DU 304 and DU 306 each have a MAC layer that implements a HARQ entity with the same HARQ ID; however, some of the HARQ processes (e.g., HARQ process IDs, HARQ process numbers, etc.) associated with the HARQ entity (e.g., HARQ ID) may be assigned or associated to DU 304 while other HARQ processes associated with the HARQ entity may be assigned or associated to DU 306. Consequently, UE 210 may use a single MAC layer and HARQ entity to communicate with DU 304 and DU 306. While not shown, DU 306 may release or terminate the MAC/HARQ configuration in response to UE 210 moving out of a coverage area of the DU 306, in response to an explicit release message from UE 210, CU 203, or another device or entity, or in response to another release trigger. As such, inter-DU, intra CU mobility of UE 210 may be enabled by configuring the MAC layers of DUs with the HARQ entity and corresponding HARQ processes.

As shown, process 600 may include CU 302 sending a HARQ process ID request to DU 306 (at 650). The HARQ process ID request may be sent via a UE setup context request message or another type of message. The HARQ process ID request may cause DU 306 to create a HARQ entity with a HARQ ID that matches the HARQ entity/ID of DU 304. In response, DU 306 to determine HARQ which HARQ processes (e.g., which HARQ process ID numbers) to use for communicating with UE 210 (at 655). In some implementations, DU 304 may determine the HARQ processes based on, at least in part, on which HARQ processes are already used by DU 304 to communicate with UE 210. For example, if DU 304 is using HARQ process ID numbers 9-16 of HARQ ID Y for communicating with UE 210, DU 306 may determine to use HARQ process ID number 1-8 of HARQ ID Y. In some implementations, one or more other or alternative factors may be used by DU 306 to determine which HARQ processes to use for communicating with UE 210. DU 306 may respond to the request from CU 302 by sending HARQ process ID preference information to CU 302 (at 660). The HARQ process ID preference information may be sent via a UE setup context response message or another type of message. The HARQ process ID preference information may indicate the HARQ processes (e.g., the HARQ process ID numbers) determined by DU 306 for communicating with UE 210.

CU 302 may send HARQ process configuration information to DU 304 (at 670). The HARQ process configuration information may be sent via a DL RRC transfer message or another type of message. The DL RRC transfer message may include an RRC reconfiguration message (e.g., an RRCReconfiguration message). The HARQ process configuration information may indicate the MAC/HARQ configuration of DU 304 and DU 306. For example, the HARQ process configuration information may indicate a HARQ entity (e.g., HARQ ID) for communicating with DU 304 and DU 306. Additionally, or alternatively, the HARQ process configuration information may indicate which HARQ processes, of the HARQ entity, correspond to DU 304 and which correspond to DU 306. In some implementations, in the event that UE 210 is to release another DU (not shown), the HARQ process configuration information may also indicate the DU and HARQ processes that should be released for that DU. In such implementations, one or more of the released HARQ processes may be reused by UE 210 to communicate with DU 304 or DU 306.

DU 304 may send an RRC reconfiguration message to UE 210 (at 680). In some implementations, one or more other types of messages may be used. The RRC reconfiguration message may include information and instructions for UE 210 to establish a connection with DU 306. In some implementations, the RRC reconfiguration message may also include information and instructions for UE 210 to reestablish or reconfigure an existing connection with DU 304. UE 210 may respond to the RRC reconfiguration message by configuring a MAC layer of UE 210 according to the HARQ entity (e.g., HARQ ID) and corresponding HARQ processes (e.g., HARQ process IDs) of DU 304 and DU 306. In such implementations, DCI from DU 304 and/or DU 306 may indicate the HARQ ID of the HARQ entity supported by DU 304 and/or DU 306. If/when there is a new ID, then bits of the DCI may reflect the new ID.

UE 210 may use the information in the RRC reconfiguration message to establish a connection with the TRPs of DU 304 and/or DU 306 (at 685). In some implementations, UE 210 may maintain the connection previously established with DU 304 (e.g., at 610) and establish an additional connection with DU 306. In some implementations, UE 210 may adjust, based on the RRC reconfiguration message, the connection previously established with DU 304 (e.g., at 610) and establish an additional connection with DU 306. In some implementations, UE 210 may establish, based on the RRC reconfiguration message, new connections with each of DU 304 and 306. UE 210 may use the connections to communicate user data (e.g., user plane information) to the network. UE 210 may communicate with DU 304 and CU 302 based on the HARQ processes associated with DU 304 (at 690). UE may communicate with DU 306 and CU 302 based on the HARQ processes associated with DU 306 (at 695). UE 210 may continue to periodically measure radio signals from base stations in the area, send measurement reports to CU 302, etc., to enable inter-DU, intra-CU mobility for UE 210 by repeating one or more of the operations of process 600.

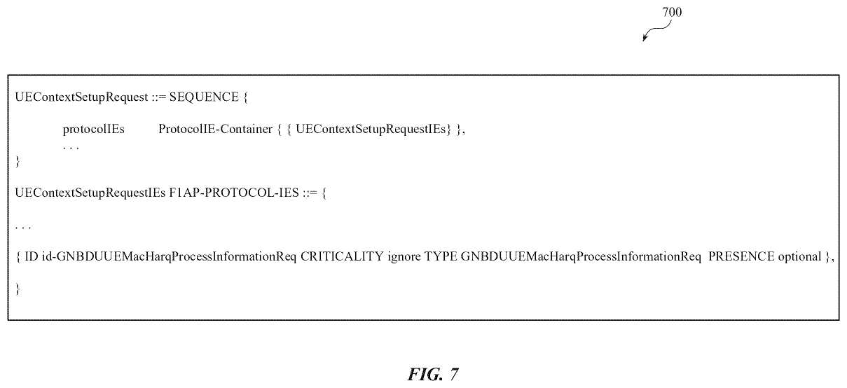

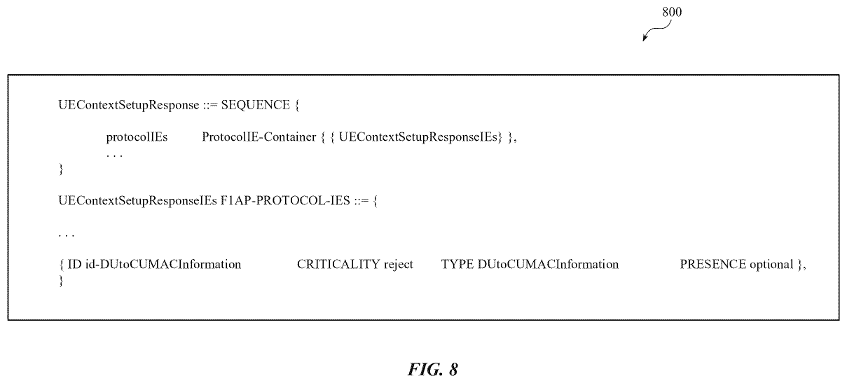

FIGS. 7-8 are diagrams of examples 700 and 800 of enhanced RRC messages and/or IEs for inter-DU, intra-CU mobility based on HARQ processes according to one or more implementations described herein. In some implementations, examples 700 and 800 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use one or more of the example 700 and 800 to implement one or more of the techniques described herein. In other implementations, CU 302, DU 304, DU 306, and/or UE 210 may use one or more additional, alternative, or differently arranged messages and/or IEs. As such, FIGS. 7-8 are provided as non-limiting examples.

Example 700 may include information and instructions that CU 302 may use to configure/reconfigure DU 306 with an appropriate MAC/HARQ entity and/or prompt DU 306 to determine and provide HARQ processes for communicating with UE 210. Example 700 may correspond to a UE context setup request message or another type of message sent from CU 302 to DU 306 via the F1 inter-node interface (see, e.g., UEContextSetupRequest, UEContextSetupRequestIEs, and F1AP-PROTOCOL-IES). Example 700 may also include information requesting MAC HARQ process ID numbers for communications between UE 210 and DU 306 (see, e.g., id-GNBDUUEMacHarqProcessInformationReq).

Example 800 may include information and instructions that DU 306 may send to CU 302 to indicate HARQ processes for communicating with UE 210. Example 800 may correspond to a UE context setup response message or another type of message sent from DU 306 to CU 302 via the F1 interface (see, e.g., UEContextSetupResponse, UEContextSetupResponseIEs, and F1AP-PROTOCOL-IES). Example 800 may also include information indicating MAC HARQ process ID numbers for UE 210 DU 306 communications and corresponding starting positions (see, e.g., id-DUtoCUMACInformation).

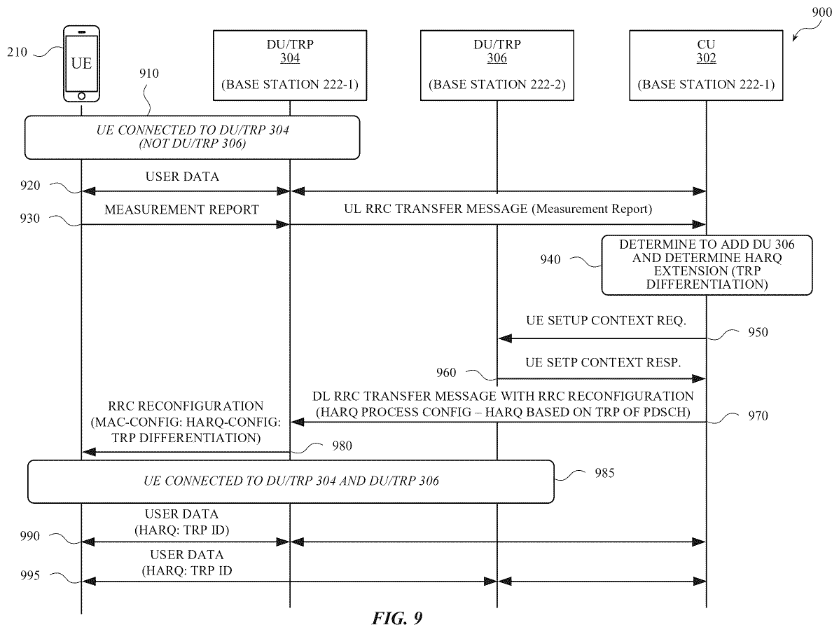

FIG. 9 is a diagram of an example of a process 900 for inter-DU, intra-CU mobility based on HARQ processes according to one or more implementations described herein. As shown, process 900 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 900 may be performed by one or more other systems or devices, including one or more of the devices of FIG. 1 or 2. Additionally, process 900 may include one or more fewer, additional, differently ordered and/or arranged operations than those shown in FIG. 9. In some implementations, one or more of the operations of process 900 may be performed independently, successively, simultaneously, etc., of one or more of the other operations of process 900. As such, the techniques described herein are not limited to the number, sequence, arrangement, timing, etc., of the operations or process depicted in FIG. 9. Additionally, an implementation involving one or more of the operations of process 900 may include one or more operations or functions of another example described herein.

As shown, process 900 may include UE 210 being connected to DU 304 of base station 222-1 (at 910). By extension, though not shown, UE 210 may also be connected to CU 302 of base station 222-1. As such, UE 210 may transmit and receive user data from base station 222-1 via DU 304 and CU 306 (at 920). UE 210 may not be connected to DU 306 of base station 222-2.

UE 210 may detect and measure signals broadcasted by base stations 222 in the area. UE 210 may send a measurement report, describing the signals detected and corresponding base stations 222 and signal strengths, to DU 304, and DU 304 may send the measurement report to CU 302 (at 930). The measurement report may be sent via a UL RRC transfer message. CU 302 may receive the measurement report and determine to enable a connection between UE 210 and DU 306 and may also determine an appropriate MAC/HARQ extension (at 940) for doing so. The MAC/HARQ extension may include a TRP differentiation technique where DU 304 and DU 306 each have a MAC layer that implements a HARQ entity with the same HARQ ID; however, a TRP ID (e.g., a PCI or another type of ID) associated with each of DU 304 and DU 306 is used to differentiate HARQ processes corresponding to DU 304 and HARQ processes corresponding to DU 306. Consequently, UE 210 may use a single MAC layer and HARQ entity to communicate with DU 304 and DU 306 because UE 210 may determine the source (e.g., DU 304 or DU 306) of communications (with the same HARQ ID and same HARQ process ID number) based on a TRP ID associated with the communication. In some implementations, CU 302 may not communicate the TRP IDs of DU 304 and 306 to UE 210. Instead, CU 302 may inform UE 210 that TRP differentiation is being used and UE 210 may determine the TRP ID of DU 304 and 306 based on the PDSCH (e.g., based on which TRP beam the UE used to demodulate the PDSCH or which carrier/TRP/beam from which the PDSCH is received.

As such, TRP differentiation may enable inter-DU, intra-CU mobility even when DU 304 and DU 306 use the same HARQ ID and the same (or overlapping) HARQ process ID numbers. Additionally (while not shown) DU 306 may release or terminate the MAC/HARQ configuration in response to UE 210 moving out of a coverage area of the DU 306, in response to an explicit release message from UE 210, CU 203, or another device or entity, or in response to another release trigger.

Process 900 may include CU 302 sending a UE setup context request message or another type of message to DU 306 (at 950). DU 306 may respond by sending CU 302 a UE setup context response message or another type of message (at 960). As TRP differentiation may enable UE 210 to determine a HARQ ID based on TRP ID, DUs 304 and 306 may use the same or different HARQ IDs. In turn, the UE setup context request and response messages from CU 302 may include the same or similar information per the 3GPP communication standards.

CU 302 may send HARQ process configuration information to DU 304 (at 970). The HARQ process configuration information may be sent via a DL RRC transfer message or another type of message. The DL RRC transfer message may include an RRC reconfiguration message (e.g., an RRCReconfiguration message). The HARQ process configuration information may include an indication that UE 210 is to implement HARQ based on a TRP IDs (e.g., based on the ID of the TRP providing a corresponding PDSCH). DU 304 may send an RRC reconfiguration message to UE 210 (at 980). In some implementations, one or more other types of messages may be used. The RRC reconfiguration message may include information and instructions for UE 210 to establish a connection with DU 306. In some implementations, the RRC reconfiguration message may also include information and instructions for UE 210 to configure a MAC layer, and corresponding HARQ entity, of UE 210 according to TRP differentiation, and in response UE 210 may do so.

UE 210 may use the information in the RRC reconfiguration message to establish a connection with the TRPs of DU 304 and/or DU 306 (at 985). In some implementations, UE 210 may maintain the connection previously established with DU 304 (e.g., at 910) and establish an additional connection with DU 306. In some implementations, UE 210 may establish, based on the RRC reconfiguration message, new connections with each of DU 304 and 306. UE 210 may use the connections to communicate user data (e.g., user plane information) to DU 304 (at 990) and DU 306 (at 995). UE 210 may communicate with DU 304, DU 306, and CU 302 by determining HARQ IDs and/or HARQ processes for DU 304 and 306 based on the TRP ID of the TRPs of DU 304, DU 306.

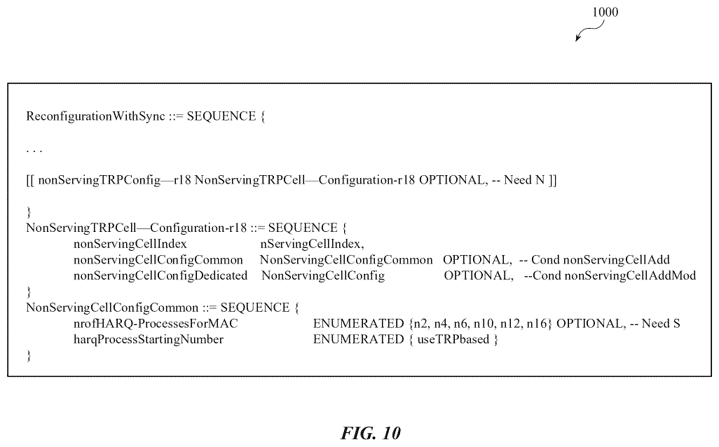

FIG. 10 is a diagram of an example of enhanced RRC messages and/or IEs for inter-DU, intra-CU mobility based on TRP ID according to one or more implementations described herein. In some implementations, example 1000 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use example 1000 to implement one or more of the techniques described herein. In other implementations, CU 302, DU 304, DU 306, and/or UE 210 may use one or more additional, alternative, or differently arranged messages and/or IEs. As such, FIG. 10 is provided as a non-limiting example.

Example 1000 may include information and instructions that CU 302 may use to configure/reconfigure UE 210 in accordance with FIG. 9. Example 1000 may be part of an RRC reconfiguration message sent from CU 302 to DU 304, and/or from DU 304 to UE 210, so that UE 210 may establish a connection with DU 306. As shown, example 1000 may include information and instructions for adding or modifying a non-serving TRP (see, e.g., NonServingTRPCell-Configuration, nonServingCellIndex and nonServingCellConfigCommon). Example 1000 may include information and instructions for implementing TRP based differentiation for HARQ procedures (see, e.g., nrofHARQ-ProcessesForMAC, harqProcessStartingNumber, and useTRPbased).

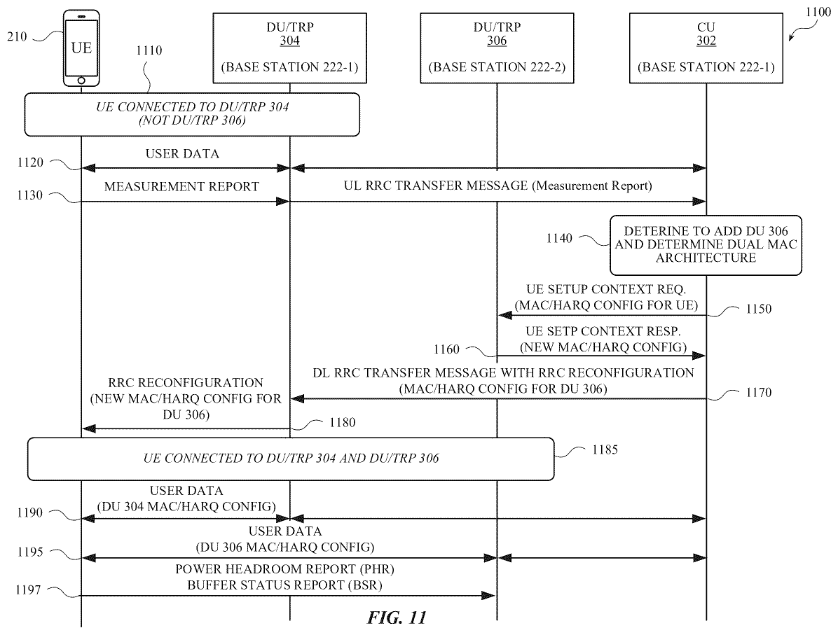

FIG. 11 is a diagram of an example of a process 1100 for inter-DU, intra-CU mobility based on a dual MAC architecture according to one or more implementations described herein. As shown, process 1100 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 1100 may be performed by one or more other systems or devices, including one or more of the devices of FIG. 1 or 2. Additionally, process 1100 may include one or more fewer, additional, differently ordered and/or arranged operations than those shown in FIG. 11. In some implementations, one or more of the operations of process 1100 may be performed independently, successively, simultaneously, etc., of one or more of the other operations of process 1100. As such, the techniques described herein are not limited to the number, sequence, arrangement, timing, etc., of the operations or process depicted in FIG. 11. Additionally, an implementation involving one or more of the operations of process 1100 may include one or more operations or functions of another example described herein.

As shown, process 1100 may include UE 210 being connected to DU 304 of base station 222-1 (at 1110). By extension, though not shown, UE 210 may also be connected to CU 302 of base station 222-1. As such, UE 210 may transmit and receive user data from base station 222-1 via DU 304 and CU 306 (at 1120). UE 210 may not be connected to DU 306 of base station 222-2.

UE 210 may detect and measure signals broadcasted by base stations 222 in the area. UE 210 may send a measurement report, describing the signals detected and corresponding base stations 222 and signal strengths, to DU 304, and DU 304 may send the measurement report to CU 302 (at 1130). The measurement report may be sent via a UL RRC transfer message. CU 302 may receive the measurement report and determine to enable a connection between UE 210 and DU 306 via a dual MAC architecture (at 1140). A dual MAC architecture, as described herein, may include a scenario in which DU 304 and DU 306 implement their own MAC/HARQ entities for communicating with UE 210, and UE 210 implements a separate MAC/HARQ entities for each of DU 304 and DU 306. Additionally, or alternatively, dual MAC architecture, as described herein, may include more than two MAC/HARQ entities for DUs/TRPs (e.g., a multi-MAC architecture).

Process 1100 may include CU 302 sending a UE setup context request message or another type of message to DU 306 (at 1150). The UE setup context request message may include information and/or instructions for DU 306 to implement a MAC layer, HARQ entity, and/or corresponding HARQ processes for communicating with UE 210. In response, DU 306 may operate in accordance with the request by creating the corresponding MAC layer, HARQ entity, and/or HARQ processes. Additionally, or alternatively, DU 306 may respond by sending CU 302 a UE setup context response message or another type of message (at 1160). The UE setup context response message may confirm that DU 306 is configured to communicate with UE 210 in accordance with the UE setup context request message and/or provide supporting or enabling information corresponding thereto.

CU 302 may send a DL RRC transfer message or another type of message to DU 304 (at 1170). The DL RRC transfer message may include an RRC reconfiguration message or RRC reconfiguration information. Additionally, or alternatively, the DL RRC transfer message may include MAC/HARQ configuration information for enabling UE 210 to communicate and establish a connection with DU 306. Examples of such information may include MAC layer configuration information, HARQ entity configuration information, HARQ processes information, etc. In response, DU 304 may send an RRC reconfiguration message to UE 210 (at 1180). In some implementations, one or more other types of messages may be used. The RRC reconfiguration message may include information and instructions for UE 210 to establish a connection with DU 306 via a dual MAC architecture. In some implementations, this may include information and instructions for UE 210 to create and configure an additional MAC layer, corresponding HARQ entity, etc., to enable UE 210 to communicate with DU 306. In such a scenario, UE 210 may support a pre-existing MAC layer and corresponding HARQ entity for DU 304 and create an additional MAC layer and corresponding HARQ entity for DU 306.

Accordingly, UE 210 may use the information in the RRC reconfiguration message to establish a connection with DU 304 and/or DU 306 (at 1185). In some implementations, UE 210 may maintain the connection previously established with DU 304 (e.g., at 1110) and establish an additional connection with DU 306. In some implementations, UE 210 may establish, based on the RRC reconfiguration message, new connections with each of DU 304 and 306. UE 210 may use the connections to communicate user data (e.g., user plane information) to DU 304 (at 1190) and DU 306 (at 1195).

As shown, UE may also, or alternatively, communicate power headroom report (PHR) information, buffer status report (BSR), and/or one or more additional or alternative types of information. UE 210 may also, or alternatively, trigger one or more processes or procedures upon adding DU 604, such as UL power handling procedures for communications toward DU 604. PHR information may include a type of MAC control element (CE) used to report an amount of headroom between a current UE Tx power and a nominal power. PHR information may indicate how much transmission power is available, or left, for UE 210 in addition to the power being used by current transmission (e.g., toward DU 604). BSR information may also include a type of MAC CE, from UE 210 to DU 306, carrying information indicating how much data is in a transmission buffer of UE 210 and waiting to be sent to DU 306.

Sending PHR information, BSR information, etc., may facility or enhance one or more dual MAC implementations, as described herein. For example, when a new beam/TRP/carrier is added, UE 210 may allocate power to transmissions in the beam/TRP/carrier, since for example, UE 210 may have a finite amount of power (based on the power-amplifier). As such, UE 210 may be configured inform that network, how much power may be allocated to the beam/TRP/carrier, as there is already some power being used to transmit on the original beam/TRP/carrier. Accordingly, one or more of the techniques, described herein, enable inter-DU, intra-CA mobility via dual MAC architectures.

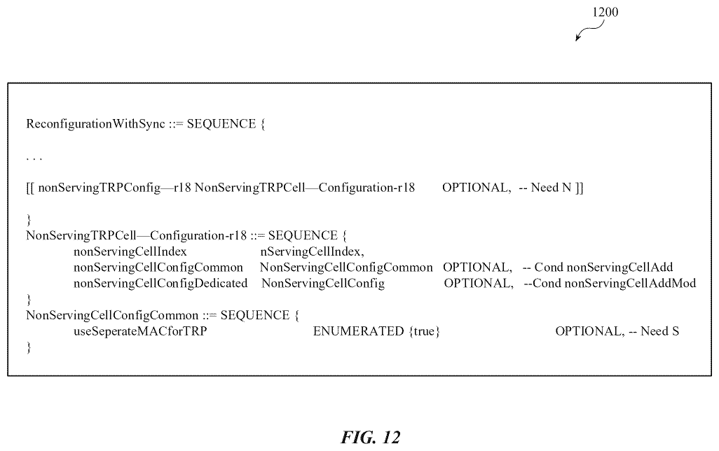

FIG. 12 is a diagram of an example of enhanced RRC messages and/or IEs for inter-DU, intra-CU mobility based on a dual MAC architecture according to one or more implementations described herein. In some implementations, example 1200 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use example 1200 to implement one or more of the techniques described herein. In other implementations, CU 302, DU 304, DU 306, and/or UE 210 may use one or more additional, alternative, or differently arranged messages and/or IEs. As such, FIG. 12 is provided as a non-limiting example.

Example 1200 may include information and instructions that CU 302 may use to configure/reconfigure UE 210 in accordance with FIG. 11. Example 1200 may be part of an RRC reconfiguration message sent from CU 302 to DU 304, and/or from DU 304 to UE 210, so that UE 210 may establish a connection with DU 306. As shown, example 1200 may include information and instructions for adding or modifying a non-serving TRP (see, e.g., NonServingTRPCell-Configuration, nonServingCellIndex and nonServingCellConfigCommon). Example 1200 may also, or alternatively, include information and instructions for enabling inter-DU, intra-CU mobility based on a dual MAC architecture (see, e.g., nonServingCellConfigCommon and useSeperateMACforTRP).

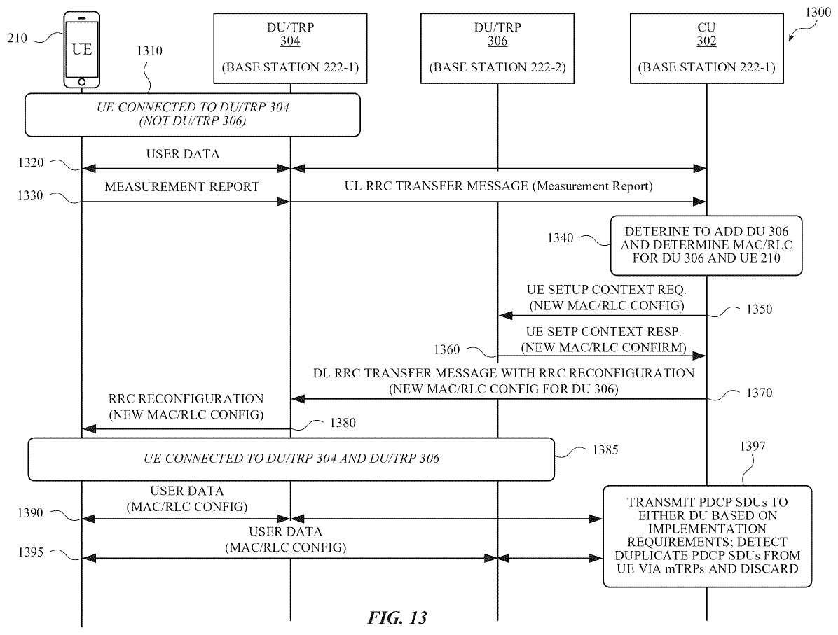

FIG. 13 is a diagram of an example of a process 1300 for inter-DU, intra-CU mobility based on a dual MAC and RLC architecture according to one or more implementations described herein. As shown, process 1300 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 1300 may be performed by one or more other systems or devices, including one or more of the devices of FIG. 1 or 2. Additionally, process 1300 may include one or more fewer, additional, differently ordered and/or arranged operations than those shown in FIG. 13. In some implementations, one or more of the operations of process 1300 may be performed independently, successively, simultaneously, etc., of one or more of the other operations of process 1300. As such, the techniques described herein are not limited to the number, sequence, arrangement, timing, etc., of the operations or process depicted in FIG. 13. Additionally, an implementation involving one or more of the operations of process 1300 may include one or more operations or functions of another example described herein.

As shown, process 1300 may include UE 210 being connected to DU 304 of base station 222-1 (at 1310). By extension, though not shown, UE 210 may also be connected to CU 302 of base station 222-1. As such, UE 210 may transmit and receive user data from base station 222-1 via DU 304 and CU 306 (at 1320). UE 210 may not be connected to DU 306 of base station 222-2.

UE 210 may detect and measure signals broadcasted by base stations 222 in the area. UE 210 may send a measurement report, describing the signals detected and corresponding base stations 222 and signal strengths, to DU 304, and DU 304 may send the measurement report to CU 302 (at 1330). The measurement report may be sent via a UL RRC transfer message. CU 302 may receive the measurement report and determine to enable a connection between UE 210 and DU 306 via a dual MAC and RLC architecture (at 1340). A dual MAC and RLC architecture, as described herein, may include a scenario in which DU 304 and DU 306 implement their own MAC/HARQ entities and RLC layers for communicating with UE 210, and UE 210 implements a separate MAC/HARQ entity and RLC layer for each of DU 304 and DU 306. In process 1300, each RLC layer/entity may be duplicates for each radio bearer (RB) supported. Additionally, or alternatively, dual MAC and RLC architecture, as described herein, may include more than two MAC/HARQ entities and RLC layers for communicating with DUs/TRPs (e.g., a multi-MAC and RLC architecture). Additionally, UE 210 may be configured to release additional MAC and RLC layers when a corresponding connection with a DU/TRP is lost or no longer in use.

Process 1300 may include CU 302 sending a UE setup context request message or another type of message to DU 306 (at 1350). The UE setup context request message may include information and/or instructions for DU 306 to implement a MAC layer, HARQ entity, corresponding HARQ processes, and/or an RLC layer for communicating with UE 210. In response, DU 306 may operate in accordance with the request by creating a protocol stack instance with the corresponding MAC layer, HARQ entity, HARQ processes, and/or RLC layer. Additionally, or alternatively, DU 306 may respond by sending CU 302 a UE setup context response message or another type of message (at 1360). The UE setup context response message may confirm that DU 306 is configured to communicate with UE 210 in accordance with the UE setup context request message and/or provide supporting or enabling information corresponding thereto.

CU 302 may send a DL RRC transfer message or another type of message to DU 304 (at 1370). The DL RRC transfer message may include an RRC reconfiguration message or RRC reconfiguration information. Additionally, or alternatively, the DL RRC transfer message may include MAC/RLC configuration information for enabling UE 210 to communicate and establish a connection with DU 306. Examples of such information may include MAC layer configuration information, HARQ entity configuration information, HARQ processes information, RLC layer configuration information, etc. In response, DU 304 may send an RRC reconfiguration message to UE 210 (at 1380). In some implementations, one or more other types of messages may be used. The RRC reconfiguration message may include information and instructions for UE 210 to establish a connection with DU 306 via a dual MAC/RLC architecture. In some implementations, this may include information and instructions for UE 210 to create and configure an additional MAC layer, corresponding HARQ entity, additional RLC layer, etc., to enable UE 210 to communicate with DU 306. In such a scenario, UE 210 may support a pre-existing MAC layer, corresponding HARQ entity, and RLC layer for DU 304 and create an additional MAC layer, corresponding HARQ entity, and RLC layer for DU 306.

Accordingly, UE 210 may use the information in the RRC reconfiguration message to establish a connection with DU 304 and/or DU 306 (at 1385). In some implementations, UE 210 may maintain the connection previously established with DU 304 (e.g., at 1310) and establish an additional connection with DU 306. In some implementations, UE 210 may establish, based on the RRC reconfiguration message, new connections with each of DU 304 and 306. UE 210 may use the connections to communicate user data (e.g., user plane information) to DU 304 (at 1390) and DU 306 (at 1395). As shown,

CU 302 may be configured to transmit PDCP service data units (SDUs) to either DU 304 or DU 306 based on configuration requirements or capabilities of DU 304 or DU 306 (at 1397). In some implementations, the PDCP SDUs may be security protected at CU 302 (e.g., at a UP 134 of CU 302) such that no additional security information is required at the DUs/TRPs. In an UL direction, CU 302 may implement a common PDCP for the dual MAC and RLC layers. RLC protocol data units (PDUs) and/or PDCP SDUs from UE 210 may arrive at the common PDCP, and the common PDCP may detect and discard duplicates, which may arrive at CU 302 via different legs of DU 304 and DU 306 (at 1397).

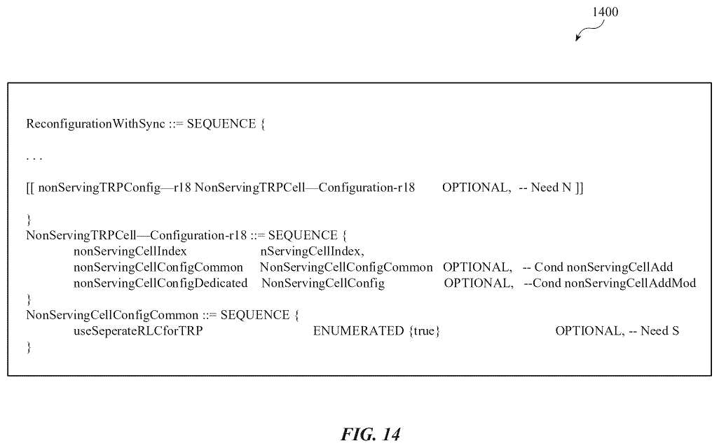

FIG. 14 is a diagram of an example of enhanced RRC IE 1400 for inter-DU, intra-CU mobility based on a dual MAC and RLC architecture according to one or more implementations described herein. In some implementations, example 1400 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use example 1400 to implement one or more of the techniques described herein. In other implementations, CU 302, DU 304, DU 306, and/or UE 210 may use one or more additional, alternative, or differently arranged messages and/or IEs. As such, FIG. 14 is provided as a non-limiting example.

Example 1400 may include information and instructions that CU 302 may use to configure/reconfigure UE 210 in accordance with FIG. 13. Example 1400 may be part of an RRC reconfiguration message sent from CU 302 to DU 304, and/or from DU 304 to UE 210, so that UE 210 may establish a connection with DU 306. As shown, example 1400 may include information and instructions for adding or modifying a non-serving TRP (see, e.g., NonServingTRPCell-Configuration, nonServingCellIndex and nonServingCellConfigCommon). Example 1400 may also, or alternatively, include information and instructions for enabling inter-DU, intra-CU mobility based on a dual MAC architecture (see, e.g., nonServingCellConfigCommon and useSeperateRLCforTRP).

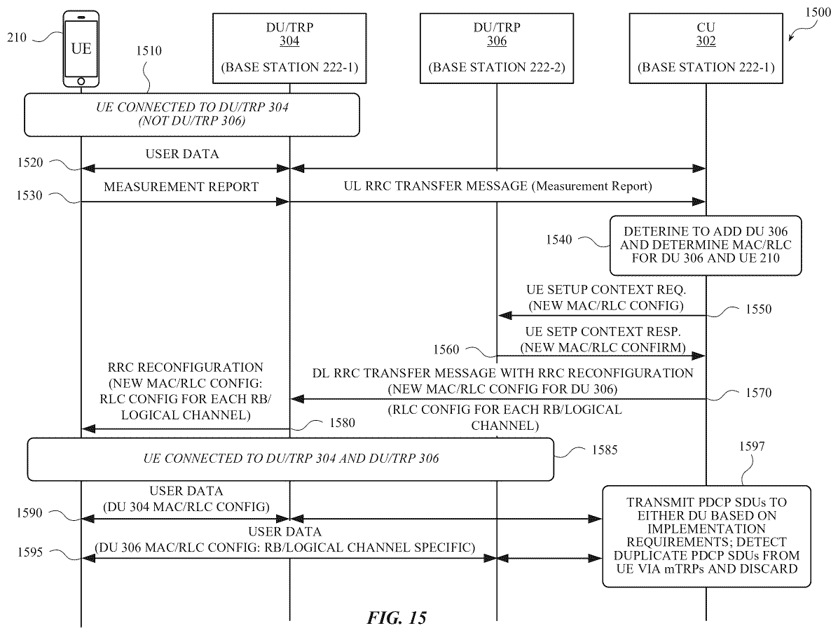

FIG. 15 is a diagram of an example of a process 1500 for inter-DU, intra-CU mobility based on a dual MAC and RLC architecture according to one or more implementations described herein. As shown, process 1500 may be implemented by UE 210, CU 302, DU/TRP 304, and DU/TRP 306. CU 302 and DU/TRP 304 may correspond to base station 222-1, and DU/TRP 306 may correspond to base station 222-2. CU 302 may be an example of CU 130 of FIG. 1, and DU/TRP 304 and DU/TRP 306 may each be examples of DU 140 and mTRP 150 of FIG. 1. For simplicity, DU/TRP 304 and DU/TRP 306 may be referred to as DU 304 and DU 306, respectively.

In some implementations, some or all of process 1500 may be performed by one or more other systems or devices, including one or more of the devices of FIG. 1 or 2. Additionally, process 1500 may include one or more fewer, additional, differently ordered and/or arranged operations than those shown in FIG. 15. In some implementations, one or more of the operations of process 1500 may be performed independently, successively, simultaneously, etc., of one or more of the other operations of process 1500. As such, the techniques described herein are not limited to the number, sequence, arrangement, timing, etc., of the operations or process depicted in FIG. 15. Additionally, an implementation involving one or more of the operations of process 1500 may include one or more operations or functions of another example described herein.

As shown, process 1500 may include UE 210 being connected to DU 304 of base station 222-1 (at 1510). By extension, though not shown, UE 210 may also be connected to CU 302 of base station 222-1. As such, UE 210 may transmit and receive user data from base station 222-1 via DU 304 and CU 306 (at 1520). UE 210 may not be connected to DU 306 of base station 222-2.

UE 210 may detect and measure signals broadcasted by base stations 222 in the area. UE 210 may send a measurement report, describing the signals detected and corresponding base stations 222 and signal strengths, to DU 304, and DU 304 may send the measurement report to CU 302 (at 1530). The measurement report may be sent via a UL RRC transfer message. CU 302 may receive the measurement report and determine to enable a connection between UE 210 and DU 306 via a dual MAC and RLC architecture (at 1540). A dual MAC and RLC architecture, as described herein, may include a scenario in which DU 304 and DU 306 implement their own MAC/HARQ entities and RLC layers for communicating with UE 210, and UE 210 implements a separate MAC/HARQ entity and RLC layer for each of DU 304 and DU 306. Additionally, or alternatively, dual MAC and RLC architecture, as described herein, may include more than two MAC/HARQ entities and RLC layers for communicating with DUs/TRPs (e.g., a multi-MAC and RLC architecture). In process 1500, RLC layers/entities may be specific to RBs or logical channels. For example, each RB supported by DU TRP 306 may have a different RLC configuration. Additionally, UE 210 may be configured to release additional MAC and RLC layers when a corresponding connection with a DU/TRP is lost or no longer in use.

Process 1500 may include CU 302 sending a UE setup context request message or another type of message to DU 306 (at 1550). The UE setup context request message may include information and/or instructions for DU 306 to implement a MAC layer, HARQ entity, corresponding HARQ processes, and/or an RLC layer for communicating with UE 210. In response, DU 306 may operate in accordance with the request by creating a protocol stack instance with the corresponding MAC layer, HARQ entity, HARQ processes, and/or RLC layer. Additionally, or alternatively, DU 306 may respond by sending CU 302 a UE setup context response message or another type of message (at 1560). The UE setup context response message may confirm that DU 306 is configured to communicate with UE 210 in accordance with the UE setup context request message and/or provide supporting or enabling information corresponding thereto.

CU 302 may send a DL RRC transfer message or another type of message to DU 304 (at 1570). The DL RRC transfer message may include an RRC reconfiguration message or RRC reconfiguration information. Additionally, or alternatively, the DL RRC transfer message may include MAC/RLC configuration information for enabling UE 210 to communicate and establish a connection with DU 306. Examples of such information may include MAC layer configuration information, HARQ entity configuration information, HARQ processes information, RLC layer configuration information, etc. In response, DU 304 may send an RRC reconfiguration message to UE 210 (at 1580). In some implementations, one or more other types of messages may be used. The RRC reconfiguration message may include information and instructions for UE 210 to establish a connection with DU 306 via a dual MAC/RLC architecture. In some implementations, this may include information and instructions for UE 210 to create and configure an additional MAC layer, corresponding HARQ entity, additional RLC layer, etc., to enable UE 210 to communicate with DU 306. The RLC layers/entities may be specific to RBs or logical channels (e.g., each RB used to enable communications between UE 210 and DU TRP 306 may have a different RLC configuration). In such a scenario, UE 210 may support a pre-existing MAC layer, corresponding HARQ entity, and RLC layer for DU 304 and create an additional MAC layer, corresponding HARQ entity, and RLC layer for DU 306.

Accordingly, UE 210 may use the information in the RRC reconfiguration message to establish a connection with DU 304 and/or DU 306 (at 1585). In some implementations, UE 210 may maintain the connection previously established with DU 304 (e.g., at 1510) and establish an additional connection with DU 306. In some implementations, UE 210 may establish, based on the RRC reconfiguration message, new connections with each of DU 304 and 306. UE 210 may use the connections to communicate user data (e.g., user plane information) to DU 304 (at 1590) and DU 306 (at 1595). As shown,

CU 302 may be configured to transmit PDCP service data units (SDUs) to either DU 304 or DU 306 based on configuration requirements or capabilities of DU 304 or DU 306 (at 1597). In some implementations, the PDCP SDUs may be security protected at CU 302 (e.g., at a UP 134 of CU 302) such that no additional security information is required at the DUs/TRPs. In an UL direction, CU 302 may implement a common PDCP for the dual MAC and RLC layers. RLC protocol data units (PDUs) and/or PDCP SDUs from UE 210 may arrive at the common PDCP, and the common PDCP may detect and discard duplicates, which may arrive at CU 302 via different legs of DU 304 and DU 306 (at 1597).

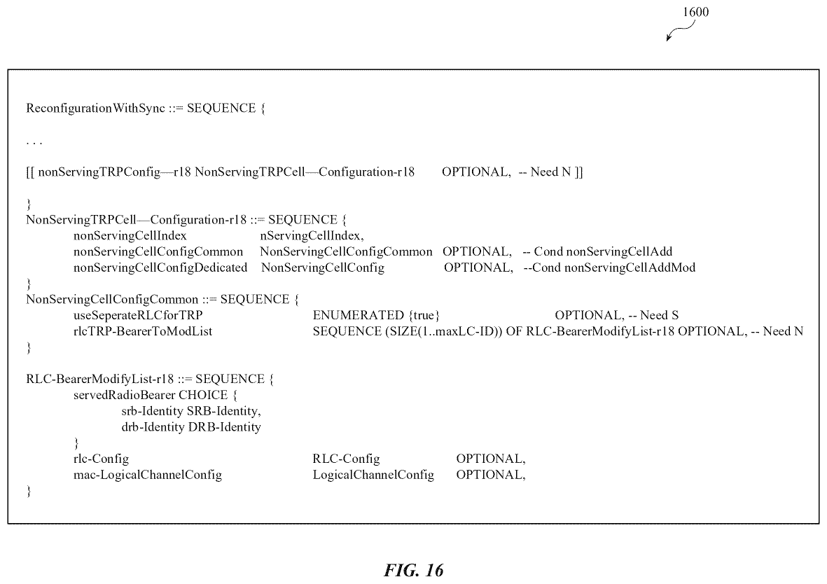

FIG. 16 is a diagram of an example of enhanced RRC IE 1600 for inter-DU, intra-CU mobility based on a dual MAC and RLC architecture according to one or more implementations described herein. In some implementations, example 1600 may represent ways in which one or more of the inter-DU, intra-CU mobility techniques, described herein, may be integrated within one or more existing 3GPP processes, IEs, RRC messages, etc. The following description does not describe all instructions and parameters of the messages and/or IEs but instead highlights example enhancements to the messages and/or IEs that may enable the techniques described herein. As such, CU 302, DU 304, DU 306, and/or UE 210 may use example 1600 to implement one or more of the techniques described herein. In other implementations, CU 302, DU 304, DU 306, and/or UE 210 may use one or more additional, alternative, or differently arranged messages and/or IEs. As such, FIG. 16 is provided as a non-limiting example.

Example 1600 may include information and instructions that CU 302 may use to configure/reconfigure UE 210 in accordance with FIG. 13. Example 1600 may be part of an RRC reconfiguration message sent from CU 302 to DU 304, and/or from DU 304 to UE 210, so that UE 210 may establish a connection with DU 306. As shown, example 1600 may include information and instructions for adding or modifying a non-serving TRP (see, e.g., NonServingTRPCell-Configuration, nonServingCellIndex and nonServingCellConfigCommon). Example 1600 may also, or alternatively, include information and instructions for enabling inter-DU, intra-CU mobility based on a dual MAC architecture (see, e.g., nonServingCellConfigCommon and useSeperateRLCforTRP). Example 1600 may also, or alternatively, include information and instructions for configuring UE 210 to support each RB used or supported by the new TRP (e.g., the TRP of DU 306) to have a different RLC configuration compared to an existing TRP (e.g., the TRP of DU 304) (see, e.g., useSeperateRLCforTRP, rlcTRP-BearerToModList, servedRadioBearer CHOICE, etc.). In such implementations, CU 302 may configure the new DU (e.g., DU 306) before configuring UE 210.

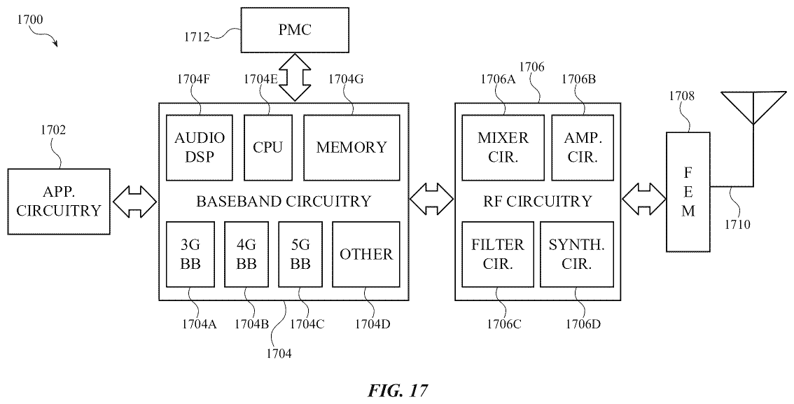

FIG. 17 is a diagram of an example of components of a device according to one or more implementations described herein. In some implementations, the device 1700 can include application circuitry 1702, baseband circuitry 1704, RF circuitry 1706, front-end module (FEM) circuitry 1708, one or more antennas 1710, and power management circuitry (PMC) 1712 coupled together at least as shown. The components of the illustrated device 1700 can be included in a UE or a RAN node. In some implementations, the device 1700 can include fewer elements (e.g., a RAN node may not utilize application circuitry 1702, and instead include a processor/controller to process IP data received from a CN such as 5GC 130 or an Evolved Packet Core (EPC)). In some implementations, the device 1700 can include additional elements such as, for example, memory/storage, display, camera, sensor (including one or more temperature sensors, such as a single temperature sensor, a plurality of temperature sensors at different locations in device 1700, etc.), or input/output (I/O) interface. In other implementations, the components described below can be included in more than one device (e.g., said circuitries can be separately included in more than one device for Cloud-RAN (C-RAN) implementations).

The application circuitry 1702 can include one or more application processors. For example, the application circuitry 1702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1700. In some implementations, processors of application circuitry 1702 can process IP data packets received from an EPC.

The baseband circuitry 1704 can include circuitry such as, but not limited to, one or more single-core or multi-core processors. The baseband circuitry 1704 can include one or more baseband processors or control logic to process baseband signals received from a receive signal path of the RF circuitry 1706 and to generate baseband signals for a transmit signal path of the RF circuitry 1706. Baseband circuitry 1704 can interface with the application circuitry 1702 for generation and processing of the baseband signals and for controlling operations of the RF circuitry 1706. For example, in some implementations, the baseband circuitry 1704 can include a 3G baseband processor 1704A, a 4G baseband processor 1704B, a 5G baseband processor 1704C, or other baseband processor(s) 1704D for other existing generations, generations in development or to be developed in the future (e.g., 2G, 6G, etc.). The baseband circuitry 1704 (e.g., one or more of baseband processors 1704A-D) can handle various radio control functions that enable communication with one or more radio networks via the RF circuitry 1706. In other implementations, some or all of the functionality of baseband processors 1704A-D can be included in modules stored in the memory 1704G and executed via a Central Processing Unit (CPU) 1704E. The radio control functions can include, but are not limited to, signal modulation/demodulation, encoding/decoding, radio frequency shifting, etc. In some implementations, modulation/demodulation circuitry of the baseband circuitry 1704 can include Fast-Fourier Transform (FFT), precoding, or constellation mapping/de-mapping functionality. In some implementations, encoding/decoding circuitry of the baseband circuitry 1704 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1704 can include one or more audio digital signal processor(s) (DSP) 1704F. The audio DSPs 1704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1704 and the application circuitry 1702 can be implemented together such as, for example, on a system on a chip (SOC).

In some implementations, the baseband circuitry 1704 can provide for communication compatible with one or more radio technologies. For example, in some implementations, the baseband circuitry 1704 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1704 is configured to support radio communications of more than one wireless protocol can be referred to as multi-mode baseband circuitry.

RF circuitry 1706 can enable communication with wireless networks using modulated electromagnetic radiation through a non-solid medium. In various implementations, the RF circuitry 1706 can include switches, filters, amplifiers, etc. to facilitate the communication with the wireless network. RF circuitry 1706 can include a receive signal path which can include circuitry to down-convert RF signals received from the FEM circuitry 1708 and provide baseband signals to the baseband circuitry 1704. RF circuitry 1706 can also include a transmit signal path which can include circuitry to up-convert baseband signals provided by the baseband circuitry 1704 and provide RF output signals to the FEM circuitry 1708 for transmission.

In some implementations, the receive signal path of the RF circuitry 1706 can include mixer circuitry 1706A, amplifier circuitry 1706B and filter circuitry 1706C. In some implementations, the transmit signal path of the RF circuitry 1706 can include filter circuitry 1706C and mixer circuitry 1706A. RF circuitry 1706 can also include synthesizer circuitry 1706D for synthesizing a frequency for use by the mixer circuitry 1706A of the receive signal path and the transmit signal path. In some implementations, the mixer circuitry 1706A of the receive signal path can be configured to down-convert RF signals received from the FEM circuitry 1708 based on the synthesized frequency provided by synthesizer circuitry 1706D. The amplifier circuitry 1706B can be configured to amplify the down-converted signals and the filter circuitry 1706C can be a low-pass filter (LPF) or band-pass filter (BPF) configured to remove unwanted signals from the down-converted signals to generate output baseband signals. Output baseband signals can be provided to the baseband circuitry 1704 for further processing. In some implementations, the output baseband signals can be zero-frequency baseband signals, although this is not a requirement. In some implementations, mixer circuitry 1706A of the receive signal path can comprise passive mixers, although the scope of the implementations is not limited in this respect.

In some implementations, the mixer circuitry 1706A of the transmit signal path can be configured to up-convert input baseband signals based on the synthesized frequency provided by the synthesizer circuitry 1706D to generate RF output signals for the FEM circuitry 1708. The baseband signals can be provided by the baseband circuitry 1704 and can be filtered by filter circuitry 1706C.

In some implementations, the mixer circuitry 1706A of the receive signal path and the mixer circuitry 1706A of the transmit signal path can include two or more mixers and can be arranged for quadrature down conversion and up conversion, respectively. In some implementations, the mixer circuitry 1706A of the receive signal path and the mixer circuitry 1706A of the transmit signal path can include two or more mixers and can be arranged for image rejection (e.g., Hartley image rejection). In some implementations, the mixer circuitry 1706A of the receive signal path and the mixer circuitry 2006A can be arranged for direct down conversion and direct up conversion, respectively. In some implementations, the mixer circuitry 1706A of the receive signal path and the mixer circuitry 1706A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1706 can include analog-to-digital converter (ADC) and digital-to-analog converter (DAC) circuitry and the baseband circuitry 1704 can include a digital baseband interface to communicate with the RF circuitry 1706.

In some dual-mode implementations, a separate radio IC circuitry can be provided for processing signals for each spectrum, although the scope of the implementations is not limited in this respect.

In some implementations, the synthesizer circuitry 1706D can be a fractional-N synthesizer or a fractional N/N+1 synthesizer, although the scope of the implementations is not limited in this respect as other types of frequency synthesizers can be suitable. For example, synthesizer circuitry 1706D can be a delta-sigma synthesizer, a frequency multiplier, or a synthesizer comprising a phase-locked loop with a frequency divider.

The synthesizer circuitry 1706D can be configured to synthesize an output frequency for use by the mixer circuitry 1706A of the RF circuitry 1706 based on a frequency input and a divider control input. In some implementations, the synthesizer circuitry 1706D can be a fractional N/N+1 synthesizer.

In some implementations, frequency input can be provided by a voltage controlled oscillator (VCO), although that is not a requirement. Divider control input can be provided by either the baseband circuitry 1704 or the applications circuitry 1702 depending on the desired output frequency. In some implementations, a divider control input (e.g., N) can be determined from a look-up table based on a channel indicated by the applications circuitry 1702.

Synthesizer circuitry 1706D of the RF circuitry 1706 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1706 can include an IQ/polar converter.

FEM circuitry 1708 can include a receive signal path which can include circuitry configured to operate on RF signals received from one or more antennas 1710, amplify the received signals and provide the amplified versions of the received signals to the RF circuitry 1706 for further processing. FEM circuitry 1708 can also include a transmit signal path which can include circuitry configured to amplify signals for transmission provided by the RF circuitry 1706 for transmission by one or more of the one or more antennas 1710. In various implementations, the amplification through the transmit or receive signal paths can be done solely in the RF circuitry 1706, solely in the FEM circuitry 1708, or in both the RF circuitry 1706 and the FEM circuitry 1708.

In some implementations, the FEM circuitry 1708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1706). The transmit signal path of the FEM circuitry 1708 can include a power amplifier (PA) to amplify input RF signals (e.g., provided by RF circuitry 1706), and one or more filters to generate RF signals for subsequent transmission (e.g., by one or more of the one or more antennas 1710).

In some implementations, the PMC 1712 can manage power provided to the baseband circuitry 1704. In particular, the PMC 1712 can control power-source selection, voltage scaling, battery charging, or DC-to-DC conversion. The PMC 1712 can often be included when the device 1700 is capable of being powered by a battery, for example, when the device is included in a UE. The PMC 1712 can increase the power conversion efficiency while providing desirable implementation size and heat dissipation characteristics.

While FIG. 17 shows the PMC 1712 coupled only with the baseband circuitry 1704. However, in other implementations, the PMC 1712 may be additionally or alternatively coupled with, and perform similar power management operations for, other components such as, but not limited to, application circuitry 1702, RF circuitry 1706, or FEM circuitry 1708.

In some implementations, the PMC 1712 can control, or otherwise be part of, various power saving mechanisms of the device 1700. For example, if the device 1700 is in an RRC_Connected state, where it is still connected to the RAN node as it expects to receive traffic shortly, then it can enter a state known as Discontinuous Reception Mode (DRX) after a period of inactivity. During this state, the device 1700 can power down for brief intervals of time and thus save power.

If there is no data traffic activity for an extended period of time, then the device 1700 can transition off to an RRC_Idle state, where it disconnects from the network and does not perform operations such as channel quality feedback, handover, etc. The device 1700 goes into a very low power state and it performs paging where again it periodically wakes up to listen to the network and then powers down again. The device 1700 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 1702 and processors of the baseband circuitry 1704 can be used to execute elements of one or more instances of a protocol stack. For example, processors of the baseband circuitry 1704, alone or in combination, can be used execute Layer 3, Layer 2, or Layer 1 functionality, while processors of the baseband circuitry 1704 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

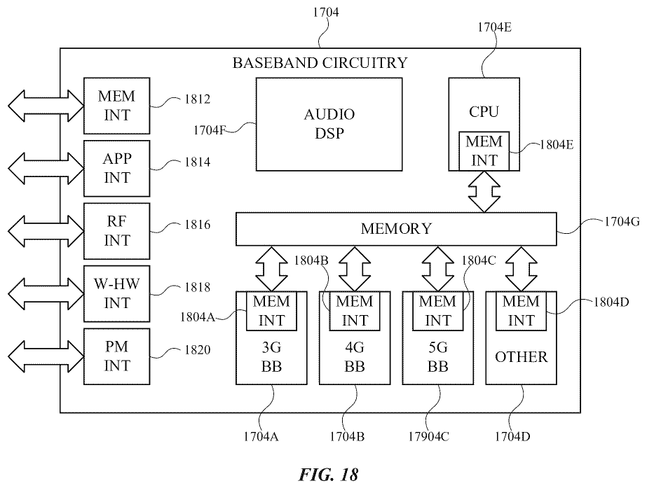

FIG. 18 is a diagram of example interfaces of baseband circuitry according to one or more implementations described herein. As discussed above, the baseband circuitry 1704 of FIG. 17 can comprise processors 1704A-2004E and a memory 1704G utilized by said processors. Each of the processors 1704A-2004E can include a memory interface, 1804A-2104E, respectively, to send/receive data to/from the memory 1704G.

The baseband circuitry 1704 can further include one or more interfaces to communicatively couple to other circuitries/devices, such as a memory interface 1812 (e.g., an interface to send/receive data to/from memory external to the baseband circuitry 1704), an application circuitry interface 1814 (e.g., an interface to send/receive data to/from the application circuitry 1702 of FIG. 17), an RF circuitry interface 1816 (e.g., an interface to send/receive data to/from RF circuitry 1706 of FIG. 17), a wireless hardware connectivity interface 1818 (e.g., an interface to send/receive data to/from Near Field Communication (NFC) components, Bluetooth® components (e.g., Bluetooth® Low Energy), Wi-Fi® components, and other communication components), and a power management interface 1820 (e.g., an interface to send/receive power or control signals to/from the PMC 1712).

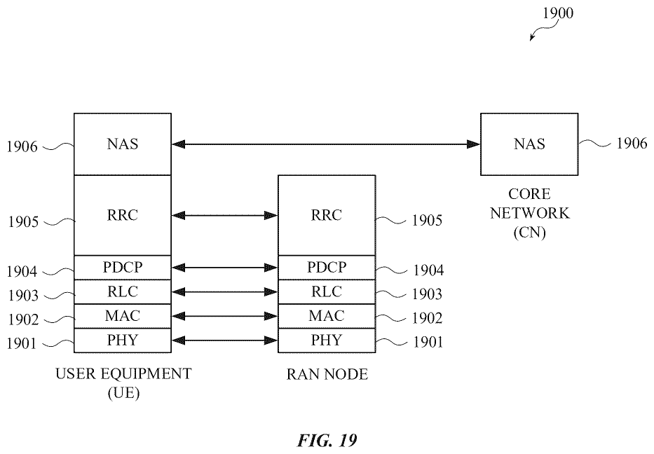

FIG. 19 is an illustration of a control plane protocol stack in accordance with some embodiments. In this embodiment, a control plane 1900 is shown as a communications protocol stack between network devices or entities.

The PHY layer 1901 may transmit or receive information used by the MAC layer 1902 over one or more air interfaces. The PHY layer 1901 may further perform link adaptation or adaptive modulation and coding (AMC), power control, cell search (e.g., for initial synchronization and handover purposes), and other measurements used by higher layers, such as the RRC layer 1905. The PHY layer 1901 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1902 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1903 may operate in a plurality of modes of operation, including: Transparent Mode (TM), Unacknowledged Mode (UM), and/or Acknowledged Mode (AM). The RLC layer 1903 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1903 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1904 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1905 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. MIBs and SIBs may comprise one or more information elements (IEs), which may each comprise individual data fields or data structures.

The UE and the RAN node may utilize a Uu interface (e.g., an NR interface) to exchange control plane data via a protocol stack comprising the PHY layer 1901, the MAC layer 1902, the RLC layer 1903, the PDCP layer 1904, and the RRC layer 1905.

The non-access stratum (NAS) protocols 1906 form the highest stratum of the control plane between the UE and the Core Network (CN). The NAS protocols 1906 may support the mobility of the UE and the session management procedures to establish and maintain IP connectivity between the UE and the network.

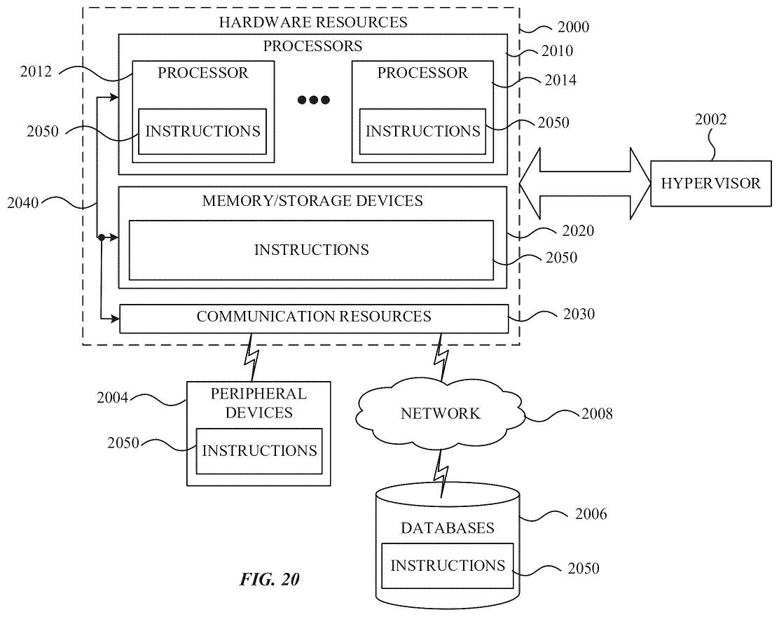

FIG. 20 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 20 shows a diagrammatic representation of hardware resources 2000 including one or more processors (or processor cores) 2010, one or more memory/storage devices 2020, and one or more communication resources 2030, each of which may be communicatively coupled via a bus 2040. For embodiments where node virtualization (e.g., NFV) is utilized, a hypervisor 2002 may be executed to provide an execution environment for one or more network slices/sub-slices to utilize the hardware resources 2000

The processors 2010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 2012 and a processor 2014.

The memory/storage devices 2020 may include main memory, disk storage, or any suitable combination thereof. The memory/storage devices 2020 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 2030 may include interconnection or network interface components or other suitable devices to communicate with one or more peripheral devices 2004 or one or more databases 2006 via a network 2008. For example, the communication resources 2030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2050 may comprise software, a program, an application, an applet, an app, or other executable code for causing at least any of the processors 2010 to perform any one or more of the methodologies discussed herein. The instructions 2050 may reside, completely or partially, within at least one of the processors 2010 (e.g., within the processor's cache memory), the memory/storage devices 2020, or any suitable combination thereof. Furthermore, any portion of the instructions 2050 may be transferred to the hardware resources 2000 from any combination of the peripheral devices 2004 or the databases 2006. Accordingly, the memory of processors 2010, the memory/storage devices 2020, the peripheral devices 2004, and the databases 2006 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a base station may comprise a centralized unit (CU) comprising one or more processors configured to: communicate with a user equipment (UE) via a first distributed unit (DU) of the base station; receive, from the UE via the first DU, a measurement report of wireless signals detected by the UE; determine, based on the measurement report, to enable a connection between the UE and a second DU; communicate, with the second DU, to configure a media access control (MAC) layer of the second DU for communicating with the UE; communicate to the UE via the first DU, a radio resource control (RRC) reconfiguration message to configure a MAC layer of the UE for communicating with the second DU; and communicate, with the UE, via a connection between the UE and the first DU and a connection between the UE and the second DU.

In example 2, which may also include one or more of the example described herein, wherein the MAC layer of the second DU includes a hybrid automatic repeat request (HARQ) entity with a HARQ ID that is equal to a HARQ ID associated with a HARQ entity of a MAC layer of the first DU.

In example 3, which may also include one or more of the example described herein, wherein the HARQ entity of the second DU is associated with different HARQ processes than the HARQ entity of the first DU.

In example 4, which may also include one or more of the example described herein, wherein the HARQ processes associated with the second DU are determined by the CU and provided to the second DU.

In example 5, which may also include one or more of the example described herein, wherein the HARQ processes associated with the second DU are determined by the DU and provided to the CU.

In example 6, which may also include one or more of the example described herein, wherein the RRC reconfiguration message enables the UE to use a single HARQ entity to communicate with the first DU and the second DU by associating different HARQ processes with the first DU than the second DU.

In example 7, which may also include one or more of the example described herein, wherein the RRC reconfiguration message enables the UE to communicate with the first DU and the second DU by associating transmission and reception point (TRP) IDs of the first DU and the second DU with HARQ processes of the first DU and the second DU.

In example 8, which may also include one or more of the example described herein, wherein the RRC reconfiguration message enables the UE to communicate with the second DU by creating an additional MAC layer and HARQ entity corresponding to the MAC layer the second DU.

In example 9, which may also include one or more of the example described herein, wherein the RRC reconfiguration message enables the UE to communicate with the second DU by creating an additional MAC layer and radio link control (RLC) layer corresponding to the MAC layer and a RLC layer of the second DU.

In example 10, which may also include one or more of the example described herein, wherein a packet data convergence protocol (PDCP) layer of the CU is configured to detect and disregard duplicate information from RLC protocol data units of the RLC layer of the first DU and the RLC layer of the second DU.

In example 11, which may also include one or more of the example described herein, wherein a plurality of radio bearers (RBs) is used for communication between the UE and the second DU, and each radio bearer, of the plurality of radio bearers, is associated with a different RLC configuration.

In example 12, which may also include one or more of the example described herein, a base station may comprise: a distributed unit (DU) comprising one or more processors configured to: receive, from a centralized unit (CU) of another base station in communication with a user equipment (UE) via another DU, a UE setup context request message; configure, in response to the UE setup context request message, a media access control (MAC) layer of the second DU for communicating with the UE; communicate, to the CU, UE setup context response message; and establish, using the MAC layer, a connection with the UE.

In example 13, which may also include one or more of the example described herein, wherein the MAC layer of the DU includes a hybrid automatic repeat request (HARQ) entity with a HARQ ID that is equal to a HARQ ID associated with a HARQ entity of a MAC layer of the another DU.

In example 14, which may also include one or more of the example described herein, wherein the HARQ entity of the DU is associated with different HARQ processes than the HARQ entity of the another DU.

In example 15, which may also include one or more of the example described herein, wherein the HARQ processes associated with the DU are determined by the CU and provided to the DU.

In example 16, which may also include one or more of the example described herein, wherein the HARQ processes associated with the DU are determined by the DU and provided to the CU.

In example 17, which may also include one or more of the example described herein, wherein the DU communicates with the UE using the different HARQ processes.

In example 18, which may also include one or more of the example described herein, wherein the DU is configured to communicate with the UE based on a transmission and reception point (TRP) ID provided to the UE by a TRP of the DU.

In example 19, which may also include one or more of the example described herein, wherein the DU is configured to create a radio link control (RLC) layer, corresponding to the MAC layer, for communicating with the UE, and to provide the CU with corresponding data plane configuration information in a UE setup context response message.

In example 20, which may also include one or more of the example described herein, wherein a plurality of radio bearers (RBs) is used for communicating with the UE, and each radio bearer, of the plurality of radio bearers, is associated with a different RLC configuration.

In example 21, which may also include one or more of the example described herein, a baseband processor of a user equipment (UE) may comprise: one or more processors configured to: communicate, to a base station comprising a first distributed unit (DU) and a centralized unit (CU), a measurement report of wireless signals detected by the UE; receive, in response to the measurement report, a radio resource control (RRC) reconfiguration message comprising information for configuring a media access control (MAC) layer of the UE to communicate with a second DU; configure, based on the RRC reconfiguration message, the MAC layer of the UE; and communicate with the first DU and the second DU.

In example 22, which may also include one or more of the example described herein, wherein the UE is to communicate with the first DU and the second DU based on different hybrid automatic repeat request (HARQ) processes, of a single HARQ entity, associated with each of the first DU and the second DU.

In example 23, which may also include one or more of the example described herein, wherein the UE is to communicate with the first DU and the second DU based on transmission and reception point (TRP) IDs of the first DU and the second DU being associated with HARQ processes of the first DU and the second DU.

In example 24, which may also include one or more of the example described herein, wherein the RRC reconfiguration message causes the UE is to configure the MAC layer by creating an additional MAC layer and HARQ entity for communicating with the second DU than a MAC layer and HARQ entity used for communicating with the first DU.

In example 25, which may also include one or more of the example described herein, wherein the RRC reconfiguration message causes the UE to configure the MAC layer by creating an additional MAC layer and radio link control (RLC) layer for communicating with the second DU than a MAC layer and RLC layer used for communicating with the first DU.

In example 26, which may also include one or more of the example described herein, wherein the UE is configured to use a plurality of radio bearers (RBs) communicating with the second DU, and each RB, of the plurality of RBs, is associated with a different RLC configuration.

In example 27, which may also include one or more of the example described herein, a method, performed by a base station, comprising operations to: communicate with a user equipment (UE) via a first distributed unit (DU) of the base station; receive, from the UE via the first DU, a measurement report of wireless signals detected by the UE; determine, based on the measurement report, to enable a connection between the UE and a second DU; communicate, with the second DU, to configure a media access control (MAC) layer of the second DU for communicating with the UE; communicate to the UE via the first DU, a radio resource control (RRC) reconfiguration message to configure a MAC layer of the UE for communicating with the second DU; and communicate, with the UE, via a connection between the UE and the first DU and a connection between the UE and the second DU.

In example 28, which may also include one or more of the example described herein, a method, performed by a base station, comprising operations to: receive, from a centralized unit (CU) of another base station in communication with a user equipment (UE) via another DU, a UE setup context request message; configure, in response to the UE setup context request message, a media access control (MAC) layer of the second DU for communicating with the UE; communicate, to the CU, UE setup context response message; and establish, using the MAC layer, a connection with the UE.

In example 29, which may also include one or more of the example described herein, a method, performed by a UE, comprising operations to: communicate, to a base station comprising a first distributed unit (DU) and a centralized unit (CU), a measurement report of wireless signals detected by the UE; receive, in response to the measurement report, a radio resource control (RRC) reconfiguration message comprising information for configuring a media access control (MAC) layer of the UE to communicate with a second DU; configure, based on the RRC reconfiguration message, the MAC layer of the UE; and communicate with the first DU and the second DU.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A centralized unit (CU) comprising memory coupled to one or more processors that are configured to:
receive, via a first connection between a user equipment (UE) and a first distributed unit (DU), a measurement report of one or more wireless signals detected by the UE;
determine, based on the measurement report, to enable a connection between the UE and a second DU;
configure a media access control (MAC) layer of the second DU for communication with the UE;
send to the UE, via the first DU, a radio resource control (RRC) reconfiguration message comprising information to configure a MAC layer of the UE for communication with the second DU; and
send signaling to the UE, via the connection between the UE and the first DU and a second connection between the UE and the second DU.

2. The CU of claim 1, wherein the MAC layer of the second DU includes a hybrid automatic repeat request (HARQ) entity with a HARQ ID that corresponds to a HARQ ID associated with a HARQ entity of a MAC layer of the first DU.

3. The CU of claim 2, wherein the HARQ entity of the second DU is associated with different HARQ processes than the HARQ entity of the first DU.

4. The CU of claim 3, wherein the HARQ processes associated with the second DU are determined by the CU and provided to the second DU.

5. The CU of claim 3, wherein the HARQ processes associated with the second DU are determined by the DU and provided to the CU.

6. The CU of claim 1, wherein the information enables the UE to use a single HARQ entity to communicate with the first DU and the second DU by associating different HARQ processes with the first DU than the second DU.

7. The CU of claim 1, wherein the information enables the UE to communicate with the first DU and the second DU by associating transmission and reception point (TRP) IDs of the first DU and the second DU with HARQ processes of the first DU and the second DU.

8. The CU of claim 1, wherein the information enables the UE to communicate with the second DU by creating an additional MAC layer; and
a HARQ entity corresponding to the MAC layer the second DU; and/or
a radio link control (RLC) layer corresponding to the MAC layer and a RLC layer of the second DU.

9. (canceled)

10. The CU of claim 8, wherein the one or more processors are further configured to:
disregard, at a packet data convergence protocol (PDCP) layer, detected duplicate information from RLC protocol data units of the RLC layer of the first DU and the RLC layer of the second DU.

11. The CU of claim 8, wherein a plurality of radio bearers (RBs) is used for communication between the UE and the second DU, and each radio bearer of the plurality of radio bearers is associated with a different RLC configuration.

12. A distributed unit (DU) comprising memory coupled to one or more processors that are configured to:
receive, from a centralized unit (CU) in communication with a user equipment (UE) via another DU, a UE setup context request message;
configure, in response to the UE setup context request message, a media access control (MAC) layer of said another DU for communication with the UE;
send, to the CU, UE setup context response message; and
establish, using the MAC layer, a connection with the UE.

13. The DU of claim 12, wherein the MAC layer of the DU includes a hybrid automatic repeat request (HARQ) entity with a HARQ ID that is equal to a HARQ ID associated with a HARQ entity of a MAC layer of the another DU.

14. The DU of claim 13, wherein the HARQ entity of the DU is associated with different HARQ processes than the HARQ entity of the another DU.

15-17. (canceled)

18. The DU of claim 12, wherein the one or more processors are further configured to: communicate with the UE based on a transmission and reception point (TRP) ID provided to the UE by a TRP of the DU.

19. The DU of claim 12, wherein the one or more processors are further configured to:
configure a radio link control (RLC) layer, corresponding to the MAC layer, for communication with the UE; and
send to the CU, data plane configuration information corresponding to the configured RLC layer, in a UE setup context response message.

20. (canceled)

21. A baseband processor of a user equipment (UE), comprising:
one or more processors configured to:
send, to a centralized unit (CU) via a first distributed unit (DU), a measurement report of one or more wireless signals detected by the UE;
receive, in response to the measurement report, a radio resource control (RRC) reconfiguration message comprising information for configuration of a media access control (MAC) layer of the UE to communicate with a second DU;
configure, based on the information, the MAC layer of the UE; and
receive first signaling from the first DU and second signaling from the second DU.

22. The UE of claim 21, wherein the first signaling received from the first DU and the second signaling received from the second DU are based on different hybrid automatic repeat request (HARQ) processes, of a single HARQ entity, associated with each of the first DU and the second DU.

23. The UE of claim 21, wherein transmission and reception point (TRP) IDs of the first DU and the second DU are associated with HARQ processes of the first DU and the second DU respectively.

24. The UE of claim 21, wherein the RRC reconfiguration message causes the UE is to configure the MAC layer by creating an additional MAC layer and HARQ entity for communication with the second DU than a MAC layer and HARQ entity used for communication with the first DU.

25. The UE of claim 21, wherein the information causes the UE to configure the MAC layer by creating an additional MAC layer and radio link control (RLC) layer for communication with the second DU different than a MAC layer and RLC layer used for communication with the first DU.

26. (canceled)
